(19) United States
(12) Patent Application Publication
(10) Pub. No.: US 2009/0093359 A1
(43) Pub. Date: Apr. 9, 2009

(54) Fiber Fabric Having VOC Removing Function

(75) Inventors: Yasutaro Seto, Osaka (JP); Tatsuo Nakamura, Nara (JP); Shuichi Yonezawa, Wakayama (JP); Kazuya Nishihara, Nara (JP); Shuichi Gennaka, Nara (JP); Yoshinari Miyamura, Osaka (JP)

Correspondence Address: KRATZ, QUINTOS & HANSON, LLP, 1420 K Street, N.W., Suite 400, WASHINGTON, DC, 20005, US

(73) Assignee: SUMINOE TEXTILE CO., LTD., Osaka-shi (JP)

(21) Appl. No.: 11/666,431

(22) PCT Filed: Oct. 19, 2005
(86) PCT No.: PCT/JP2005/019173

§ 371 Date: Apr. 27, 2007

(30) Foreign Application Priority Data
Oct. 27, 2004 (JP) 2004-312119
Dec. 6, 2004 (JP) 2004-352214
May 26, 2005 (JP) 2005-153247

(51) Int. Cl. B01J 29/04

(52) U.S. Cl. 502/62

(57) ABSTRACT

A fiber fabric having a VOC removing function according to the present invention has a hydrophobic inorganic porous substance and a photocatalyst adhered to at least a part of the fiber fabric with binder resin. With this, not only formaldehyde and acetaldehyde but also VOCs having an aromatic ring such as toluene and xylene can be adequately decomposed, which prevents cross-contamination by intermediate products formed during the decomposition.

### TECHNICAL FIELD

The present invention relates to a fiber fabric having a deodorant function, an antibacterial function and an antifouling function and capable of effectively removing VOCs (Volatile Organic Compounds) represented by, e.g., formaldehyde, acetaldehyde, toluene and xylene. The fiber fabric according to the present invention can be widely applied to interior fiber fabrics such as, e.g., curtains fabrics, carpet fabrics, wallpaper fabrics or upholstery fabrics, or interior fiber fabrics for use in automobiles, vehicles, ships or aircrafts.

### BACKGROUND TECHNIQUE

In recent years, as represented by sick house syndrome, living environmental pollution problems caused by hazardous substances such as, e.g., formaldehyde, generated from, e.g., housing materials have quickly grown into serious problems. The use of not only formaldehyde but also persistent VOCs (Volatile Organic Compound) having an aromatic ring such as, e.g., toluene and xylene, has become regulated by an Indoor Air Environmental Guideline.

In the meantime, it is known that a photocatalyst has an ability of decomposing organic materials, etc., into carbon dioxide gas and water. For example, it is popularly practiced that a photocatalyst is firmly fixed to a fiber fabric such as, e.g., a curtains fabric, a carpet fabric, a wallpaper fabric or an upholstery fabric, to decompose the bad odor or the hazardous substances utilizing ultraviolets or visible lays. Furthermore, it is also confirmed that a photocatalyst has a function of killing coil bacteria by its strong oxidizability.

Although a photocatalyst has such a useful function, direct fixing of a photocatalyst to a fiber fabric with a binder resin causes several problems such as, decomposition of the fiber fabric, coloring of the fiber fabric, or generation of bad odor by the strong oxidative decomposition power of the photocatalyst since the binder resin and the fiber fabric are made of resin containing organic carbon hydride. Under the circumstances, the use of a photocatalyst is limited. In many cases, a photocatalyst is applied to inorganic materials such as, e.g., tiles or glasses strong against oxidization, and therefore used outdoors.

Furthermore, if a photocatalyst is used indoors, it was hard to completely decompose persistent materials such as, e.g., toluene or xylene, into carbon hydrate gas and water because the amount of ultraviolet existing in a room is very few, and various intermediates (low-molecular weight decomposition products) are generated, causing secondary pollution. Even if a photocatalyst which responses to visible rays is used, it was also difficult to immediately decompose VOCs into carbon dioxide gas and water due to the low energy, causing intermediates, which in turn causes secondary pollution.

In order to improve the above, Patent Document 1 discloses a technique in which a titanium oxide photocatalyst is fixed to a fiber fabric with a silicon cross-link type resin to thereby provide a fiber fabric which does not cause decoloration and/or deterioration in use and has long-lasting excellent deodorant, antibacterial and antifouling functions.

Furthermore, Patent Document 2 discloses a technique in which an anticorrosive skin of fluorine resin is formed on a surface of a fiber fabric and a photocatalyst skin is formed on the anticorrosive skin to thereby eliminate decoloration and deterioration of the fiber fabric and eliminate odor of acetaldehyde.

Patent Document 3 discloses a technique for providing an interior finishing material excellent in enduring odor prevention, deodorant nature, antibacterial nature, antifouling nature in which binder selected from the group consisting of an alkyl silicate series resin, a silicone series resin and a fluorine series resin and a photocatalyst are fixed on a surface of a fiber fabric.

Patent Document 4 discloses a technique of forming anatase type oxide titanium having photocatalytic activity in silica gel by impregnating a titan solution such as organotitanium in silica gel pores and then sintering it.

Patent Document 5 discloses that the use of cellulose series binder as binder causes positive decomposition of the binder with a photocatalyst into carbon dioxide gas while preventing generation of new low-molecular volatile materials.

Patent Document 6 discloses a technique in which hydrazine derivative and deodorant inorganic substance are fixed to a carpet to deodorize the carpet.

Patent Document 1: Japanese Unexamined Laid-open Patent Publication No. H10-1879

Patent Document 2: Japanese Unexamined Laid-open Patent Publication No. H10-216210

Patent Document 3: Japanese Unexamined Laid-open Patent Publication No. 2001-254281

Patent Document 4: Japanese Unexamined Laid-open Patent Publication No. 2004-305947

Patent Document 5: Japanese Unexamined Laid-open Patent Publication No. 2004-137611

Patent Document 6: Japanese Unexamined Laid-open Patent Publication No. 2000-14520

### DISCLOSURE OF THE INVENTION

### Problems to be Solved by the Invention

In the methods disclosed by the aforementioned Patent Documents 1, 2 and 3, however, the texture of the fiber fabric may sometimes become hard, it was impossible to completely protect the fiber fabric from secondary pollution from oxidizing property of a photocatalyst, and it was also difficult to remove VOCs having an aromatic ring such as, e.g., toluene or xylene. According to the technique disclosed by Patent Document 4, although the decomposition of the binder resin and the fiber fabric can be restrained, gases of VOC, etc., cannot be trapped in the pores of the silica gel because silica gel itself lacks sufficient absorption power for absorbing hydrophobic organic substances such as VOCs, resulting in a failure of VOC decomposition by a photocatalyst.

The present invention was made in view of the aforementioned technical background. The first object of the present invention is to provide a fiber fabric having a VOC removing function capable of sufficiently decomposing and removing not only formaldehyde and acetaldehyde but also VOCs having an aromatic ring such as, e.g., toluene or xylene and also capable of preventing secondary pollution by intermediate products generated by decomposition while maintaining soft texture of the fiber fabric. Furthermore, the second object of the present invention is to provide a fiber fabric having a VOC removing function capable of sufficiently preventing decoloration or deterioration of the fabric.

### Means to Solve the Problems

In order to attain the aforementioned objects, the present invention provided the following means.

[1] A fiber fabric having a VOC removing function, wherein a hydrophobic inorganic porous substance and a photocatalyst are fixed to at least a part of the fiber fabric with a binder resin.

[2] The fiber fabric having a VOC removing function as recited in the aforementioned Item 1, wherein the hydrophobic inorganic porous substance is hydrophobic zeolite.

[3] The fiber fabric having a VOC removing function as recited in the aforementioned Item 1 or 2, wherein the photocatalyst is visible light response type titanium oxide photocatalyst.

[4] The fiber fabric having a VOC removing function as recited in any one of the aforementioned Items 1 to 3, wherein the binder resin is an acrylic silicon series binder resin.

[5] The fiber fabric having a VOC removing function as recited in any one of the aforementioned Items 1 to 4, wherein an average grain diameter of the hydrophobic inorganic porous substance is 20 nm to 30 μm.

The fiber fabric having a VOC removing function as recited in any one of the aforementioned Items 1 to 5, wherein an average grain diameter of the photocatalyst is 5 nm to 20 μm.

[7] The fiber fabric having a VOC removing function as recited in any one of the aforementioned Items 1 to 6, wherein an average grain diameter of the photocatalyst is not larger than one-tenth part ( 1/10) of a diameter of a fiber constituting the fiber fabric.

[8] The fiber fabric having a VOC removing function as recited in any one of the aforementioned Items 1 to 7,

wherein an adhered amount of the hydrophobic inorganic porous substance adhered to the fiber fabric is 0.1 to 15 mass parts with respect to the fiber fabric 100 mass parts,

wherein an adhered amount of the photocatalyst adhered to the fiber fabric is 0.5 to 25 mass parts with respect to the fiber fabric 100 mass parts, and

wherein an adhered amount of the binder resin adhered to the fiber fabric is 0.05 to 30 mass parts with respect to the fiber fabric 100 mass parts.

[9] The fiber fabric having a VOC removing function as recited in any one of the aforementioned Items 1 to 8, wherein the binder resin is fixed to the fiber fabric in an approximately mesh-like manner.

[10] A fiber fabric having a VOC removing function, wherein a hydrophobic inorganic porous substance in which a photocatalyst is fixed in pores is fixed to at least a part of a fiber fabric with a binder resin.

[11] The fiber fabric having a VOC removing function as recited in the aforementioned Item 10, wherein the hydrophobic inorganic porous substance is hydrophobic zeolite.

[12] The fiber fabric having a VOC removing function as recited in the aforementioned Item 10 or 11, wherein an average grain diameter of the hydrophobic inorganic porous substance is 20 nm to 30 μm.

[13] The fiber fabric having a VOC removing function as recited in any one of the aforementioned Items 10 to 12, wherein an average grain diameter of the hydrophobic inorganic porous substance is not larger than one-tenth part ( 1/10) of a diameter of a fiber constituting the fiber fabric.

[14] The fiber fabric having a VOC removing function as recited in any one of the aforementioned Items 10 to 13, wherein an adhered amount of the hydrophobic inorganic porous substance in which the photocatalyst is fixed in the pores adhered to the fiber fabric is 0.1 to 15 mass parts with respect to the fiber fabric 100 mass parts, and

wherein an adhered amount of the binder resin adhered to the fiber fabric is 0.05 to 30 mass parts with respect to the fiber fabric 100 mass parts.

[15] The fiber fabric having a VOC removing function as recited in any one of the aforementioned Items 10 to 14, wherein the binder resin is fixed to the fiber fabric in an approximately mesh-like manner.

[16] A fiber fabric having deodorant, antibacterial and VOC removing functions, wherein a visible light response type photocatalyst, an absorbing agent made of a hydrophobic inorganic porous substance, and a deodorant made of an amine compound are fixed to at least a part of a fiber fabric with a binder resin.

[17] The fiber fabric having deodorant, antibacterial and VOC removing functions as recited in the aforementioned Item 16, wherein the visible light response type photocatalyst is visible light response type titanium oxide photocatalyst.

[18] The fiber fabric having deodorant, antibacterial and VOC removing functions as recited in the aforementioned Item 16 or 17, wherein the absorbing agent made of the hydrophobic inorganic porous substance is hydrophobic zeolite.

[19] The fiber fabric having deodorant, antibacterial and VOC removing functions as recited in any one of the aforementioned Items 16 to 18, wherein the deodorant made of the amine compound is hydrazine derivative.

[20] The fiber fabric having deodorant, antibacterial and VOC removing functions as recited in any one of the aforementioned Items 16 to 19, wherein the binder resin is an acrylic silicon series binder resin.

[21] The fiber fabric having deodorant, antibacterial and VOC removing functions as recited in any one of the aforementioned Items 16 to 20, wherein an average grain diameter of the visible light response type photocatalyst is 5 nm to 20 μm.

[22] The fiber fabric having deodorant, antibacterial and VOC removing functions as recited in any one of the aforementioned Items 16 to 21, wherein an average grain diameter of the absorbing agent made of the hydrophobic inorganic porous substance is 20 nm to 30 μm.

[23] The fiber fabric having deodorant, antibacterial and VOC removing functions as recited in any one of the aforementioned Items 16 to 22, wherein an average grain diameter of the deodorant made of the amine compound is 20 nm to 30 μm.

[24] The fiber fabric having deodorant, antibacterial and VOC removing functions as recited in any one of the aforementioned Items 16 to 23,

wherein an adhered amount of the visible light response type photocatalyst adhered to the fiber fabric is 0.1 to 15 mass parts with respect to the fiber fabric 100 mass parts,

wherein an adhered amount of the absorbing agent made of the hydrophobic inorganic porous substance adhered to the fiber fabric is 0.5 to 20 mass parts with respect to the fiber fabric 100 mass parts, and

wherein an adhered amount of the deodorant made of the amine compound adhered to the fiber fabric is 0.5 to 30 mass parts with respect to the fiber fabric 100 mass parts.

### EFFECTS OF THE INVENTION

According to the invention as recited in the aforementioned Item [1], since a hydrophobic inorganic porous substance is fixed to at least a part of the fiber fabric with the binder resin, the fiber fabric is excellent in affinity for VOCs having an aromatic ring such as, e.g., toluene or xylene strong in hydrophobic nature. In other words, a hydrophobic inorganic porous substance strongly draws VOCs having an aromatic ring such as, e.g., toluene or xylene, thereby enabling high-efficient decomposition and removal of VOCs having an aromatic ring such as, e.g., toluene or xylene. Furthermore, even in cases where intermediate products (low-molecular-weight decomposition products) are generated by decomposition effects of the photocatalyst, the intermediate products can be effectively captured by absorption, which can prevent cross-contamination by intermediate products generated by the decomposition. Furthermore, the intermediate products captured by the hydrophobic inorganic porous substance will be finally decomposed by the photocatalyst into carbon dioxide gas and water. Thus, complete decomposition and removal of VOCs can be performed.

According to the invention as recited in the aforementioned invention [2], since hydrophobic zeolite is used as the hydrophobic inorganic porous substance, the intermediate products generated by the decomposition effects of the photocatalyst can be effectively captured.

According to the invention as recited in the aforementioned invention [3], since visible light response type oxide titanium photocatalyst is used as a photocatalyst, even in cases where the fiber fabric is used within a room less in amount of ultraviolet, sufficient VOC decomposing and removing functions can be secured. Furthermore, the fiber fabric can easily eliminate smell of tobacco smoke, smell of sweat, etc., and also can decompose colored materials such as tobacco-tar adhered to the fabric, resulting in excellent antifouling effect and excellent antibacterial effect. In cases where such visible light response type photocatalyst is used, it is generally difficult to decompose intermediate products into carbon dioxide gas and water. As a result, in many cases, cross-contamination by the generated intermediate products becomes problematic. In the fiber fabric according to the present invention, however, the fabric can effectively capture such intermediate products by adsorption by the hydrophobic inorganic substance, which effectively prevents cross-contamination due to intermediate products generated by such decomposition.

According to the invention as recited in the aforementioned invention [4], acrylic silicon series binder resin is used as a binder resin. A photocatalyst will be bonded to the silicone portion of the acrylic series binder as silanol bond, while the acrylic portion of the acrylic silicone series binder resin will be firmly bonded to the fiber fabric. As mentioned above, since the photocatalyst is not directly bonded to the fiber fabric but the silicone portion and the acrylic portion are bonded to the photocatalyst and the fiber fabric respectively, the fiber fabric can be protected from the strong oxidative effect of the photocatalyst, which in turn can prevent discoloration and deterioration. Furthermore, the photocatalyst is bonded to the silicone portion of the acrylic silicone series binder resin whose acrylic portion is bonded to the fiber fabric, or the photocatalyst is indirectly bonded to the fiber fabric, which does not deteriorate the soft texture of the fiber fabric.

According to the invention as recited in the aforementioned invention [5], the hydrophobic inorganic porous substance is 20 nm to 30 μm in average grain diameter, which prevents the texture of the fiber fabric from being roughened.

According to the invention as recited in the aforementioned invention [6], the photocatalyst is 5 nm to 20 μm in average grain diameter, which can further enhance the odor eliminating rate and the VOC decomposing and eliminating rate.

According to the invention as recited in the aforementioned invention [7], the average grain diameter of the photocatalyst is not larger than 1/10 of the diameter of the fiber constituting the fiber fabric, which can effectively prevent detachment of the photocatalyst.

According to the invention as recited in the aforementioned invention [8], the sufficient VOC decomposing and eliminating function can be secured while maintaining the preferable texture as a fiber fabric.

According to the invention as recited in the aforementioned invention [9], the binder resin is fixed to the fiber fabric in an approximately mesh-like manner. This enables free relative movements of the fibers constituting the fiber fabric, which can secure sufficient softness as a fiber fabric. Furthermore, it becomes possible to remain a space (room) for giving functions other than deodorant, antibacterial, antifouling, VOC removing functions. For example, it is possible to give another functions such as, e.g., flame resisting, water repellent finishing, or oil repellent finishing, which further enhances the multifunctionality.

According to the invention as recited in the aforementioned invention [10], the hydrophobic inorganic porous substance in which the photocatalyst is fixed in pores is fixed to at least a part of the fiber fabric with a binder resin. Therefore, the fiber fabric is excellent in affinity for VOCs having an aromatic ring such as, e.g., toluene or xylene strong in hydrophobic nature. Therefore, a hydrophobic inorganic porous substance in which the photocatalyst is fixed in pores strongly draws VOCs having an aromatic ring such as, e.g., toluene or xylene, thereby enabling high-efficient decomposition and removal of VOCs having an aromatic ring such as, e.g., toluene or xylene by the photocatalyst. Furthermore, even in cases where intermediate products (low-molecular-weight decomposition products) are generated by decomposition effects of the photocatalyst, the intermediate products can be effectively absorbed and captured by the hydrophobic inorganic porous substance. Therefore, VOCs will be finally decomposed by the photocatalyst into carbon dioxide gas and water. Thus, complete decomposition and removal of VOCs can be performed. Furthermore, the photocatalyst is fixed to the inside of pores of the hydrophobic inorganic porous substance and not exposed to the surface thereof. Therefore, the fiber fabric can easily eliminate smell of tobacco smoke, smell of sweat, etc., and also can decompose colored materials such as tobacco-tar adhered to the fabric, resulting in excellent antifouling effect and excellent antibacterial effect.

According to the invention as recited in the aforementioned invention [11], the hydrophobic inorganic porous substance fixed to the inside of pores is hydrophobic zeolite in which the photocatalyst is fixed to the inside of the pores. Therefore, the fiber fabric can more efficiently absorb and capture the intermediate products by the decomposition effects of the photocatalyst. Especially, since the hydrophobic zeolite absolves less water, even in an atmosphere high in humidity, the hydrophobic zeolite can effectively absorb intermediate products generated during the photocatalyst reaction, which prevents cross-contamination by the intermediate products.

According to the invention as recited in the aforementioned invention [12], the hydrophobic inorganic porous substance is 20 nm to 30 μm in average grain diameter, which prevents the texture of the fiber fabric from being hardened or roughened.

According to the invention as recited in the aforementioned invention [13], an average grain diameter of the hydrophobic inorganic porous substance in which the photocatalyst is fixed in pores is not larger than 1/10 of a diameter of a fiber constituting the fiber fabric, which can effectively prevent detachment of the hydrophobic inorganic porous substance in which the photocatalyst is fixed in the pores.

According to the invention as recited in the aforementioned invention [14], a sufficient VOC removing function can be secured while maintaining preferable texture as a fiber fabric.

According to the invention as recited in the aforementioned invention [15], the binder resin is fixed to the fiber fabric in an approximately mesh-like manner. This enables free relative movements of the fibers constituting the fiber fabric, which can secure sufficient softness as a fiber fabric. Furthermore, it becomes possible to remain a space (room) for giving functions other than deodorant, antibacterial, antifouling, VOC removing functions. For example, it is possible to give another functions such as, e.g., flame resisting, water repellent finishing, or oil repellent finishing, which further enhances the multifunctionality.

According to the invention as recited in the aforementioned invention [16], the visible light response type photocatalyst and the absorbing agent made of hydrophobic inorganic porous substance are fixed to the fiber fabric. Therefore, the fiber fabric is excellent in affinity for VOCs having an aromatic ring such as, e.g., toluene or xylene strong in hydrophobic nature. In other words, a hydrophobic inorganic porous substance strongly draws VOCs having an aromatic ring such as, e.g., toluene or xylene, thereby enabling high-efficient decomposition and removal of VOCs having an aromatic ring such as, e.g., toluene or xylene even in a room weak in light. Furthermore, even in cases where intermediate products (low-molecular-weight decomposition products) are generated by decomposition effects of the visible light response type photocatalyst, the intermediate products can be effectively absorbed and captured, which can prevent the fiber fabric from being cross-contaminated with intermediate products generated by the decomposition. Furthermore, the intermediate products captured by the hydrophobic inorganic porous substance will be finally decomposed by the visible light response type photocatalyst into carbon dioxide gas and water. Furthermore, deodorant made of amine compound is fixed to the fiber fabric, which can eliminate many unpleasant odors such as, e.g., hydrosulfuric odor, ammonia odor, smell of tobacco smoke, smell of sweat, etc.

According to the invention as recited in the aforementioned invention [17], visible light response type titanium oxide photocatalyst is used as a visible light response type photocatalyst. Therefore, even in cases where the fiber fabric is used within a room with less amount of ultraviolet, the VOC removing function can be secured. Furthermore, it can eliminate unpleasant odors such as, e.g., smell of ammonia, or smell of tobacco smoke. However, in cases where such visible light response type photocatalyst is used, it is generally difficult to immediately decompose all unpleasant odors and VOCs into carbon dioxide gas and water. As a result, in many cases, cross-contamination by the generated intermediate products becomes problematic. In the fiber fabric according to the present invention, however, the hydrophobic inorganic porous substance can effectively absorb and capture such intermediate products, which effectively prevents such problems. It is acknowledge that the visible light response type titanium oxide photocatalyst has excellent deodorant, antibacterial and antifouling functions.

According to the invention as recited in the aforementioned invention [18], hydrophobic zeolite is used as the absorbing agent made of a hydrophobic inorganic porous substance. Since the hydrophobic zeolite absolves less water, even in an atmosphere high in humidity, the intermediate products generated during the photocatalyst reaction can be effectively absorbed, which prevents cross-contamination by the intermediate products, resulting in assured decomposition and elimination of VOCs.

According to the invention as recited in the aforementioned invention [19], since hydrazine derivative is used as a deodorant agent made of an amine compound, many unpleasant odors such as, e.g., hydrosulfuric odor, ammonia odor, smell of tobacco smoke, smell of sweat, etc, can be eliminated.

According to the invention as recited in the aforementioned invention [20], since acrylic silicon series binder resin is used as a binder resin, the photocatalyst and the fiber fabric do not comes into direct contact with each other while keeping the soft texture, which prevents deterioration of the fiber fabric.

According to the invention as recited in the aforementioned invention [21], since the visible light response type photocatalyst is 5 nm to 20 μm in average grain diameter, deodorant, antibacterial, and VOC removing functions can be further enhanced while preventing the texture from being hardened.

According to the invention as recited in the aforementioned invention [22], since the absorbing agent made of a hydrophobic inorganic porous substance is 20 nm to 30 μm in average grain diameter, deodorant, antibacterial, and VOC removing functions can be further enhanced while maintaining preferable texture as a fiber fabric.

According to the invention as recited in the aforementioned invention [23], since the deodorant made of an amine compound is 20 nm to 30 μm in average grain diameter, a deodorant function can be further enhanced while maintaining the preferable texture as a fiber fabric.

According to the invention as recited in the aforementioned invention [24], the adhered amount of the visible light response type photocatalyst adhered to the fiber fabric is 0.1 to 15 mass parts with respect to 100 mass parts of the fiber fabric, the amount of the absorbing agent made of a hydrophobic inorganic porous substance adhered to the fiber fabric is 0.5 to 20 mass parts with respect to 100 mass parts of the fiber fabric, and the amount of the deodorant made of an amine compound adhered to the fiber fabric is 0.5 to 30 mass parts with respect to 100 mass parts of the fiber fabric. Therefore, a fiber fabric having sufficient deodorant, antibacterial, and VOC removing functions can be provided.

### BEST MODE FOR CARRYING OUT THE INVENTION

The fiber fabric having a VOC removing function according to the first invention is characterized in that a hydrophobic inorganic porous substance and a photocatalyst are fixed to at least at part of a fiber fabric with a binder resin.

In the fiber fabric according to the first invention, since the hydrophobic inorganic porous substance is fixed to the fiber fabric, it is excellent in affinity for VOCs having an aromatic ring such as, e.g., toluene or xylene strong in hydrophobic nature. That is, a hydrophobic inorganic porous substance strongly draws VOCs having an aromatic ring such as, e.g., toluene or xylene which is strong in hydrophobic nature, thereby resulting in many VOCs collected on the surface of the photocatalyst. This enables high efficient decomposition and removal of VOCs having an aromatic ring such as, e.g., toluene or xylene. Furthermore, even in cases where intermediate products (low-molecular-weight decomposition products) are generated by decomposition effects of the photocatalyst, the intermediate products can be effectively absorbed and captured by the hydrophobic inorganic porous substance to prevent them from being released into atmospheric air. This can prevent cross-contamination by intermediate products generated by the decomposition. Furthermore, the intermediate products captured by the hydrophobic inorganic porous substance will be finally decomposed by the photocatalyst into carbon dioxide gas and water, thereby enabling complete decomposition and removal of VOCs. The aforementioned “VOC (Volatile Organic Compound)” denotes a generic term of an organic compound which evaporates (vaporizes) at normal temperature.

In order to fully obtain the aforementioned collaboration actions of the hydrophobic inorganic porous substance and the photocatalyst (i.e., to completely decompose and remove VOCs), it is preferable to configure such that the hydrophobic inorganic substance and the photocatalyst are fixed to at least a part of the fiber fabric with a binder resin in a mixed manner.

In the first invention, the fiber fabric is not specifically limited, but can be, for example, a woven fabric, a knitted fabric, a non-woven fabric, a raised fabric (e.g., a tufted carpet, a moquette). Furthermore, the type or form of the fiber constituting the fiber fabric is not specifically limited. Examples of the fiber constituting the fiber fabric include a synthetic fiber such as, e.g., an polyester fiber, a polyamide fiber or an acrylic fiber, a semisynthetic fiber such as, e.g., an acetate fiber, or a rayon fiber, and a natural fiber such as, e.g., wool, silk, cotton, or hemp. It can be configured to use one or two or more types of these fibers.

The photocatalyst is not specifically limited. For example, titanium oxide, lead oxide, zinc oxide, and ferric oxide can be exemplified as the photocatalyst. These photocatalysts are generally energized by ultraviolet or visual lights to convert, e.g., water or oxygen into OH radical or O₂⁻ which exhibits strong oxidizing properties. Thus, organic substances can be decomposed by these oxidizing properties. In order to enhance the photocatalyst activities, it can be configured such that it carries metallic platinum such as, e.g., platinum, palladium, or rhodium, or that it carries bactericidal metal such as, e.g., silver, copper, or zinc.

Among other things, as the photocatalyst, it is preferable to use a visual light response type photocatalyst. In this case, even in cases where it is used within a room with less amount of ultraviolet, a sufficient VOC decomposing and removing function can be fulfilled. It is more preferable to use a visual light response type titanium oxide photocatalyst. Since such visual light response type titanium oxide photocatalyst exerts strong oxidative effects even in a room with less amount of ultraviolet, the VOC decomposing and removing function can be further enhanced. Furthermore, the photocatalyst can easily eliminate smell of tobacco smoke, smell of sweat, etc., and also can decompose colored materials such as tobacco-tar adhered to a fabric, resulting in excellent antifouling effect. Furthermore, a visual light response type titanium oxide photocatalyst can exert excellent disinfecting power against Staphylococcus aureus by its oxidizing power, which makes it possible to secure excellent antibacterial effectiveness.

The visual light response type titanium oxide photocatalyst is configured to be excited in a visual light range by, e.g., performing an N-dope to a part of titanium oxide, but not specifically limited. For example, an anion dope type in which a part of O of titanium oxide is replaced with N or S and a cation type in which a part of Ti of titanium oxide is replaced with Cr or V can be exemplified. As such visual light response type titanium oxide photocatalyst, it is preferable to use anatase type titanium oxide, rutile type oxide titanium or brookite type titanium oxide. The most preferable one is anatase type titanium oxide.

Furthermore, as such visual light response type titanium oxide photocatalyst, apatite coating visual light response type titanium oxide photocatalyst can also be used. This apatite coating visual light response type titanium oxide photocatalyst is a composite material in which the surface of the visual light response type titanium oxide photocatalyst is coated with calcium phosphate apatite. This apatite coating visual light response type titanium oxide photocatalyst can prevent a visual light response type titanium oxide photocatalyst from coming into direct contact with a fiber fabric or a binder resin to thereby prevent decomposition of the fiber fabric or binder resin by strong oxidizing effects of the photocatalyst.

The average grain diameter of the photocatalyst is preferably 5 nm to 20 μm (0.005 μm to 20 μm). It is preferable that the average grain diameter of the photocatalyst is smaller from the view point of its oxidative effects. However, a photocatalyst having a grain diameter of less than 5 nm is very difficult in manufacturing and expensive in manufacturing cost, and therefore it is not preferable. On the other hand, if the grain diameter exceeds 20 μm, the decomposition removing rate by the photocatalyst deteriorates, and therefore it is also not preferable. Among other things, it is more preferable that the average grain diameter of the photocatalyst falls within the range of 7 nm to 5 μm (0.007 μm to 5 μm).

Furthermore, the average grain diameter of the photocatalyst is preferably one-tenth part ( 1/10) of the diameter of the fiber constituting the fiber fabric. In this case, there is a merit that detachment of the photocatalyst from the fiber fabric can be effectively prevented.

The adhered amount of the photocatalyst adhered to the fiber fabric is preferably 0.5 to 25 mass parts with respect to the fiber fabric 100 mass parts. If it exceeds 25 mass parts, the texture of the fabric becomes hard and the fiber fabric whitens, and therefore it is not preferable. On the other hand, if it is less than 0.5 mass parts, since the odor eliminating rate and/or the VOC decomposing and removing rate deteriorate, and therefore it is not preferable. Among other things, the adhered amount of the photocatalyst adhered to the fiber fabric is more preferably 0.7 to 10 mass parts with respect to the fiber fabric 100 mass parts.

As the hydrophobic inorganic porous substance, it is not specifically limited. For example, hydrophobic zeolite, activated carbon, alumina porous particles with the surface coated with fluorine resin and porous oxidized silicon with the surface coated with water repellant can be exemplified. Among other things, it is preferable to use hydrophobic zeolite. In this case, intermediate products created by the decomposing effects of the photocatalyst can be absorbed and captured more effectively by the hydrophobic zeolite. Furthermore, since hydrophobic zeolite is white in color, it can be preferably applied to interior fiber fabrics or the like which give importance to color and/or design. It should be noted that the aforementioned “hydrophobic inorganic porous substance” does not include water-absorbing inorganic porous substance.

It is preferable to use hydrophobic zeolite having a SiO₂/Al₂O₃ molar ratio of 30 or more, more preferably hydrophobic zeolite having SiO₂/Al₂O₃ molar ratio of 60 or more.

As a method of obtaining the hydrophobic zeolite, for example, a method of directly synthesizing high Si/Al ratio zeolite such as silicalite, a method of removing Al within the zeolite skeleton and a method of modifying the zeolite surface silanol group can be exemplified. As a method of removing Al in zeolite skelton by aftertreatment, a method of subjecting NH₄⁺ type or H⁺ type zeolite to hydrothermal treatment at high temperature and then to acid treatment, a method of removing Al directly by acid treatment and a method of treating in an EDTA water solution can be exemplified. As a method of modifying the zeolite surface silanol group, a method of introducing alkyl group (hydrophobic group) by the reaction to alkylsilane or alcohol can be exemplified.

It is preferable that the average grain diameter of the hydrophobic inorganic porous substance is 20 nm to 30 μm (0.02 μm to 30 μm). If it exceeds 30 μm, it is not preferable since the texture of the fiber fabric becomes hard. On the other hand, if it is less than 20 nm, it is very difficult in production and high in production cost, and therefore it is not preferable. Among other things, the average grain diameter of the hydrophobic inorganic porous substance is preferably 100 nm to 10 μm.

The adhered amount of the hydrophobic inorganic porous substance adhered to the fiber fabric is preferably 0.1 to 15 mass parts with respect to fiber fabric 100 mass parts. If it exceeds 15 mass parts, the texture of the fabric becomes hard and the fiber fabric whitens, and therefore it is not preferable. On the other hand, if it is less than 0.1 mass part, since the power of absorbing intermediate products generated by the decomposing effects of the photocatalyst deteriorates, and therefore it is not preferable. Among other things, the adhered amount of the hydrophobic inorganic porous substance adhered to the fiber fabric is more preferably 0.5 to 10 mass parts with respect to the fiber fabric 100 mass parts.

As to the binder resin, although it is not specifically limited, it is preferable to use an acrylic silicon binder resin. The acrylic silicon binder resin is a binder rein having silicon group and acrylic group. As concrete examples, for example, a resin obtained by block-copolymerizing acrylic resin unit and silicon resin unit, and a complex resin obtained by graft-polymerizing polymethacrylate unit to silicon resin can be exemplified.

In cases where the acrylic silicon binder resin is used, the photocatalyst is bonded to the silicon portion of the acrylic silicon binder resin by the silanol bond, while the acrylic portion of the acrylic silicon binder is strongly bonded to the fiber fabric. The acrylic portion of the acrylic silicon binder resin has a very strong bonding force to synthetic fibers such as, e.g., acrylic fibers, nylon fibers, polyester fibers, and therefore the acrylic portion preferentially binds to a fiber fabric. As will be apparent from the above, the photocatalyst is not directly bonded to a fiber fabric, but the acrylic portion and the fiber fabric are selectively bonded respectively. Therefore, it becomes possible to protect the fiber fabric from the strong oxidative effects of the photocatalyst, which can prevent discoloration and/or deterioration of the fiber fabric. Furthermore, the photocatalyst is indirectly bounded to the fiber fabric such that the acrylic portion is bounded to the silicon portion of the acrylic silicon binder resin bounded to the fiber fabric, and therefore the soft texture of the fiber fabric will not be deteriorated. Furthermore, since the silicon portion of the acrylic silicon binder resin has sufficient resistance against oxidative effects of the photocatalyst, decomposition of the silicon portion by the oxidative effects of the photocatalyst would not occur.

The adhered amount of the binder resin adhered to the fiber fabric is preferably 0.05 to 30 mass parts with respect to the fiber fabric 100 mass parts. If it is less than 0.05 mass parts, it is not preferable since the adhering force deteriorates, causing easy detachment of the hydrophobic inorganic porous substance and the photocatalyst. If it exceeds 30 mass parts, the texture of the fiber fabric becomes hard and therefore it is not preferable.

A fiber fabric having a VOC removing function according to the first aspect of the present invention can be manufactured, for example, as follows. That is, the fiber fabric can be manufactured by bonding processing liquid containing a hydrophobic inorganic porous substance, a photocatalyst and a binder resin to at least a part of the fiber fabric, and then drying it. That is, a fiber fabric in which the hydrophobic inorganic porous substance and the photocatalyst are bonded in a mixed dispersion state by the binder resin can be obtained. Concretely, an immersion method and a coating method can be exemplified.

As the immersion method, for example, a method in which a fiber fabric is immersed in a processing liquid containing the hydrophobic inorganic porous substance, the photocatalyst and the binder resin and then the fiber fabric is squeezed with a mangle and dried can be exemplified. By manufacturing the fiber fabric using this immersion method, there is a merit that the processing liquid containing the hydrophobic inorganic porous substance, the photocatalyst, and the binder resin can be evenly held by the fiber fabric.

As the coating method, for example, a method in which processing liquid containing a hydrophobic inorganic porous substance, a photocatalyst, and a binder resin is applied to at least a part of the fiber fabric to be coated and then dried can be exemplified. By manufacturing a fiber fabric by this method, there is a merit that the productivity can be remarkably improved and the carrying amount can be controlled with a high degree of accuracy. Furthermore, this coating method can bond the binder resin in an approximately mesh-like manner. Although the concrete method of this method is not specifically limited, for example, a gravure roll method, a transfer print method, and a screen print method can be exemplified.

The blend ratio of each component in the processing liquid is not specifically limited. However, if the amount of the binder resin with respect to the amount of the photocatalyst becomes too large, the ratio of covering the surface of the photocatalyst with the binder resin increases, which deteriorates the odor eliminating effect, the antibacterial effect, the antifouling effect and the VOC removing effect, and therefore it is not preferable. The appropriate blending quantity with respect to the binder resin 100 mass parts is 10 to 250 mass parts of the hydrophobic inorganic porous substance and 10 to 250 mass parts of the photocatalyst.

The application processing to the fiber fabric can be performed by separate two steps. That is, at the first step, the binder resin is applied to the fiber fabric. Thereafter, at the second step, the hydrophobic inorganic porous substance and the photocatalyst are applied to the fiber fabric. With this method, the hydrophobic inorganic porous substance and the photocatalyst can be applied evenly and efficiently.

Although the fiber fabric having a VOC removing function according to the first invention is not specifically limited, for example, the fiber fabric can be used as, e.g., an interior fiber fabric for use in automobiles, vehicles, vessels, aircrafts, etc., or clothes, as well as interior fabrics for carpets, curtains, wall-coverings, or upholstery fabrics.

Next, the fiber fabric having a VOC removing function according to the second invention will be explained. The fiber fabric having a VOC removing function according to the second invention is characterized in that a hydrophobic inorganic porous substance in which a photocatalyst is fixed in pores is fixed to at least a part of a fiber fabric.

In this second invention, as the form of the fiber fabric, a woven fabric, a knitted fabric, and a nonwoven fabric or a raised fabric such as, e.g., a tufted carpet or a moquette can be exemplified, but not limited thereto. The fiber of the fiber fabric is not specifically limited, and can be a synthetic fiber such as, e.g., a polyester fiber, a polyamide fiber, or an acrylic fiber, a semisynthetic fiber such as, e.g., an acetate fiber or a rayon fiber, and a natural fiber such as, e.g., a wool fiber, a silk fiber, a cotton fiber, or a hemp fiber. It is possible to employ the structure in which one or more of the aforementioned fibers are used.

As a photocatalyst for giving functions such as, e.g., an antibacterial function, an antifouling function, and/or a VOC removing function, in general, titanium oxide, tin oxide, zinc oxide, and ferric oxide can be exemplified. These photocatalysts are generally energized by ultraviolet or visual lights to convert, e.g., water or oxygen into OH radical or O₂⁻ which exhibits strong oxidizing properties. Thus, organic substances can be decomposed into water and carbon dioxide by these oxidizing properties. In order to enhance the photocatalyst activities, it can be configured such that it carries metallic platinum such as, e.g., platinum, palladium, or rhodium, or that it carries bactericidal metal such as, e.g., silver, copper, or zinc.

The hydrophobic inorganic porous substance in which a photocatalyst is fixed in pores according to the second invention can be obtained by impregnating a photocatalyst within pores of a hydrophobic inorganic porous substance and burning it. The photocatalyst carried within the pores of the hydrophobic inorganic porous substance is an extremely highly dispersed photocatalyst which exhibits efficient activity to odorous gas even under weak lights. Furthermore, it can easily eliminate smell of tobacco smoke, smell of sweat, etc., and also can decompose colored materials such as, e.g., tobacco-tar adhered to a fabric, resulting in excellent antifouling and antibacterial effects.

The fixing of the photocatalyst in pores of the hydrophobic inorganic porous substance can be performed by, for example, impregnating titanium solution in hydrophobic zeolite, drying it and then burning it for about 6 hours at 500° C. As the immersing titanium solution, a titanium oxalate solution, a tetrachlorotitanium solution, a titanyl sulfate solution, and an alkoxy titanium solution can be exemplified. Among other things, titanyl oxalate is preferably used since it easily changes into titanium oxide by pyrolysis and it is stable and safe. The fixation of the titanium oxide in the pores can be confirmed by ultraviolet absorption spectra, X-Ray diffraction measurement, or an electron microscope. The titanium oxide fixed in the pores of the hydrophobic zeolite is an extremely highly dispersed titanium oxide which exhibits efficient VOC removing efficient even under weak lights.

The fixed amount of the titanium oxide in the pores is preferably 3 to 50 mass parts with respect to hydrophobic zeilite 100 mass parts. If it is less than 3 mass parts, the photocatalyst ability deteriorates, and therefore it is not preferable. On the other hand, if it exceeds 50 mass parts, the titanium oxide will be fixed not only in the zeolite pores but also on the surface of the zeolite. This causes a direct contact with the binder resin and/or the fiber fabric, and therefore it is not preferable.

As for the hydrophobic inorganic porous substance, it is not specifically limited. For example, hydrophobic zeolite, activated carbon, silica gel, and oxidized silicon can be exemplified. Among other things, it is preferable to use hydrophobic zeolite. In this case, the intermediate product created by the decomposing effects of the photocatalyst can be absorbed and captured more effectively by the hydrophobic zeolite. Furthermore, since zeolite is white in color, it can be preferably applied to an interior fiber fabric or the like which gives importance to color and/or design. It should be noted that the aforementioned “hydrophobic inorganic porous substance” does not include water-absorbing inorganic porous substance. Although zeolite is generally hydrophilic, hydrophobic zeolite is preferably used in this invention. Since the hydrophobic zeolite is few in water absorption, it can quickly and effectively absorb bad smell and intermediate products to be created during the photocatalyst reactions even in the atmosphere high in humidity.

It is preferable to use hydrophobic zeolite having a SiO₂/Al₂O₃ molar ratio of 30 or more, more preferably hydrophobic zeolite having SiO₂/Al₂O₃ molar ratio of 60 or more.

As a method of obtaining the hydrophobic zeolite, for example, a method of directly synthesizing high Si/Al ratio zeolite such as silicalite, a method of removing Al within the zeolite skeleton by aftertreatment and a method of modifying the zeolite surface silanol group can be exemplified. As a method of removing Al in zeolite skelton by aftertreatment, a method of subjecting NH₄⁺ type or H⁺ type zeolite to hydrothermal treatment at high temperature and then to acid treatment, a method of removing Al directly by acid treatment and a method of treating in an EDTA water solution can be exemplified. As a method of modifying the zeolite surface silanol group, a method of introducing alkyl group (hydrophobic group) by the reaction to alkylsilane or alcohol can be exemplified.

The hydrophobic inorganic porous substance has numerous pores having a diameter of 0.2 to 100 nm extending from the surface of the substance toward the insider thereof. Thus, the specific surface area is as large as 5.0 to 1,500 m²/g. Among other things, it is preferable that the hydrophobic inorganic porous substance is 0.5 to 10 nm in average pore diameter from the view point of fixing a photocatalyst in pores. If the average pore diameter is too small, although the specific surface area increases, a photocatalyst hardly enters into the pores, resulting in deteriorated deodorant ability. On the other hand, if the average pore diameter exceeds 10 nm, the specific surface area decreases, resulting in deteriorated deodorant ability. The specific surface area can be measured by a BET method which calculates the specific surface from the nitrogen absorbing amount.

It is preferable that the average grain diameter of the hydrophobic inorganic porous substance fixed in pores of the photocatalyst is 20 nm to 30 μm. If the grain diameter of the hydrophobic inorganic porous substance exceeds 30 μm, it is not preferable since the texture of the fiber fabric becomes hard. On the other hand, if it is less than 20 nm, the amount of the photocatalyst to be fixed in pores decreases, resulting in deteriorated VOC removing ability, which is not preferable. Among other things, it is more preferable that the average grain diameter of the hydrophobic inorganic porous substance in which the photocatalyst is fixed in the pores is 100 nm to 10 μm. Furthermore, if it is one tenth-part ( 1/10) of a diameter of the fiber constituting the fiber fabric, the fixation to the fiber becomes strong, which effectively prevents detachment of the hydrophobic inorganic porous substance due to friction, etc.

The adhered amount of the hydrophobic inorganic porous substance in which the photocatalyst is fixed in the pores is preferably 0.5 to 15 mass parts with respect to fiber fabric 100 mass parts. If it exceeds 15 mass parts, the texture of the fabric becomes hard and the fiber fabric whitens, and therefore it is not preferable. On the other hand, if it is less than 0.5 mass parts, the VOC removing power deteriorates, and therefore it is not preferable. Among other things, the adhered amount of the hydrophobic inorganic porous substance in which the photocatalyst is fixed in the pores adhered to the fiber fabric is more preferably 0.5 to 10 mass parts with respect to the fiber fabric 100 mass parts.

Next, as the binder resin, any resin can be used. Examples thereof include, for example, a self cross-link type acrylic type resin, a methacrylic resin, a urethane resin, a silicon resin, glyoxal resin, a polyvinyl acetate resin, a vinylidene chloride resin, a butadiene resin, a melamine resin, epoxy resin, an acrylic silicon copolymer resin, an ethylene-vinylacetate copolymer resin, an isobutylene-maleic anhydride copolymer resin, and an ethylene-stylene-acrylate-metacrylate copolymer resin. A combination of two or more of the aforementioned resins can be used as the binder resin.

The adhered amount of the binder resin adhered to the fiber fabric is preferably 0.05 to 30 mass parts with respect to the fiber fabric 100 mass parts. If it is less than 0.05 mass parts, it is not preferable since the adhering force deteriorates, causing easy detachment of the hydrophobic inorganic porous substance in which the photocatalyst is fixed in the pores. If it exceeds 30 mass parts, the texture of the fiber fabric becomes hard and therefore it is not preferable.

The fiber fabric having a VOC removing function according to the second invention can be manufactured, for example, as follows. That is, the fiber fabric can be manufactured by making a solution in which the hydrophobic inorganic porous substance in which the photocatalyst is fixed in the pores and the binder resin are dispersed in water adhere to at least a part of the fiber fabric and then drying it. At this time, as to the solution, it is preferable that the hydrophobic inorganic substance in which the photocatalyst is fixed in the pores and the binder resin are dispersed as much as possible. As to the binder resin, it is preferable to form emulsion with water. At the time of blending, in order to more evenly disperse the binder resin, preferably, the hydrophobic inorganic porous substance in which the photocatalyst is preliminarily fixed in the pores is dispersed in water, and then the binder resin is dispersed therein.

As a method for fixing the solution to the fiber fabric, an immersion method and a coating method can be exemplified. As an immersion method, a method in which a fiber fabric is immersed in the solution and then squeezed with a mangle and then dried can be exemplified. By manufacturing the fiber fabric using this immersion method, the hydrophobic inorganic porous substance in which the photocatalyst is fixed in the pores and the binder resin can be evenly fixed to the fiber fabric.

As the coating method, for example, a method in which the solution is applied to at least a part of the fiber fabric and then dried can be exemplified. By manufacturing a fiber fabric by the coating method, there is a merit that the productivity can be remarkably improved and the adhered amount can be controlled with a high degree of accuracy. Although a concrete method of the coating method is not specifically limited, for example, a gravure roll method, a spray method, a roll coater method, a transfer print method, and a screen print method can be exemplified.

The coating method is a useful processing method for applying the solution not in a entirely applied manner forming a skin layer on the fiber fabric but in a mesh-like manner. In this method, the solution is not entirely adhered in a layer-like manner but adhered in a mesh-like manner, which allows relative movements of the strings constituting the fiber fabric. This secures the softness of the fiber fabric, and also keeps spaces for giving functions other than deodorant, antibacterial and antifouling functions, which in turn makes it possible to give additional functions such as, e.g., a fire resisting function, a water-shielding function and an oil-shielding function.

The blend ratio of the hydrophobic inorganic porous substance in which the photocatalyst is fixed in the pores to the binder resin is not specifically limited. However, if the amount of the binder resin blending amount increases, the ratio of covering the surface of the hydrophobic inorganic porous substance with the binder resin increases, which deteriorates the odor eliminating effect, the antibacterial effect, the antifouling effect and the VOC removing effect, and therefore it is not preferable. The appropriate blending quantity with respect to the binder resin 100 mass parts is the hydrophobic inorganic porous substance 50 to 100 mass parts in which the photocatalyst is fixed in the pores.

Although the fiber fabric having a VOC removing function according to the second invention is not specifically limited, for example, the fiber fabric can be used as, e.g., an interior fiber fabric for use in automobiles, vehicles, vessels, aircrafts, etc., as well as interior fabrics for curtains, carpets, wall-coverings, or upholstery fabrics. Furthermore, the combination with another deodorant agent such as, e.g., hydrazine derivative or amine compound can provide a deodorant fiber fabric having a high-performance VOC removing function.

Next, the fiber fabric having a deodorant function, an antibacterial function and a VOC removing function according to a third invention will be explained. The fiber fabric according to the third invention is characterized in that an deodorant agent including 1) a visible light response type photocatalyst, 2) an absorbing agent made of a hydrophobic inorganic porous substance, and 3) an deodorant agent made of an amine compound is adhered to at least a part of the fiber fabric with a binder resin.

The fiber fabric according to the third invention can be widely used as, e.g., interior fabrics for curtains, carpets, wall-coverings, or upholstery fabrics, or an interior fiber fabric for use in automobiles, vehicles, vessels, aircrafts, etc. As the form of the fiber fabric, a woven fabric, a knitted fabric, and a nonwoven fabric or a raised fabric such as a tufted carpet or a moquette can be exemplified, but not limited thereto. The fiber constituting the fiber fabric is not specifically limited, and can be one or a plurality of fibers selected from the group consisting of a synthetic fiber such as, e.g., a polyester fiber, a polyamide fiber, or an acrylic fiber, a semisynthetic fiber such as, e.g., an acetate fiber or a rayon fiber, and a natural fiber such as, e.g., a wool fiber, a silk fiber, a cotton fiber, or a hemp fiber.

Although the mechanism of the third invention is not fully clarified, the visual light response type photocatalyst is bonded to the silicon portion of the acrylic silicon binder resin by the silanol bond, while the acrylic portion of the acrylic silicon binder resin is strongly bonded to the fiber fabric. As explained above, the visual light response type photocatalyst is not directly bonded to the fiber fabric, but the silicon portion and the acrylic portion are selectively bonded to the visual light response type catalyst and the fiber fabric respectively. Therefore, it is considered that it becomes possible to prevent the discoloration and/or deterioration of the fiber fabric due to the strong oxidative effects of the photocatalyst. Furthermore, since the visual light response type photocatalyst, the absorbing agent, the deodorant agent are indirectly bounded to the fiber fabric via the acrylic portion, the soft texture of the fiber fabric can be maintained.

Furthermore, the visual light response type photocatalyst fixed to the fiber fabric by the binder resin exerts the deodorant performance and the antibacterial performance and decomposes VOCs, while intermediate products produced by not being decomposed into carbon dioxide and water will be captured by the absorbing agent fixed to the fiber fabric by the binder resin in the same manner as in the visual light response type photocatalyst. Therefore, the VOC removing function can be exerted without releasing the intermediate products into the air. Furthermore, the intermediate products captured by the absorbing agent will be finally decomposed into carbon dioxide gas and water by the visual light response type photocatalyst and the deodorant agent.

As the visual light response type photocatalyst to be used in the third invention, a visual light response type titanium oxide, tin oxide, zinc oxide, and ferric oxide can be exemplified. Even in cases where it is used in a room with less irradiance level of ultraviolet, the visual light response type photocatalyst is energized by visual lights or ultraviolet to convert, e.g., water or oxygen into OH radical or O₂⁻ which decomposes organic substances by the strong oxidizing properties. In order to enhance the activities of the visual light response type photocatalyst, it can be configured such that it carries metallic platinum such as, e.g., platinum, palladium, or rhodium, or that it carries bactericidal metal such as, e.g., silver, copper, or zinc.

Among other things, a visual light response type titanium oxide photocatalyst exerts strong oxidative effects even in cases where it is used within a room with less irradiance level of ultraviolet. Therefore, it is excellent in VOC decomposing and removing function, and can easily eliminate smell of tobacco smoke, smell of sweat, etc. It also can decompose colored materials such as tobacco-tar adhered to a fabric, resulting in excellent antifouling effect.

Furthermore, it is known that a visual light response type titanium oxide photocatalyst exerts excellent disinfecting power against, e.g., staphylococcus aureus by its oxidizing power, which restrains bad odor generated when bacteria decomposes human body metabolite, etc., to thereby secure antibacterial effectiveness.

The visual light response type titanium oxide photocatalyst is configured to be excited in a visual light range by, e.g., performing an N-dope to a part of titanium oxide and is not specifically limited. For example, an anion dope type in which a part of O of titanium oxide is replaced with N or S and a cation type in which a part of Ti of titanium oxide is replaced with another atom can be exemplified. As such visual light response type titanium oxide photocatalyst, it is preferable to use anatase type titanium oxide, rutile type titanium oxide or brookite type titanium oxide. The most preferable one is anatase type titanium oxide.

Furthermore, in the third invention, as such a visual light response type titanium oxide photocatalyst, apatite coating visual light response type titanium oxide photocatalyst can also be used. This apatite coating visual light response type titanium oxide photocatalyst is a composite material in which the surface of the visual light response type titanium oxide photocatalyst is coated with calcium phosphate apatite. This apatite coating visual light response type titanium oxide photocatalyst can prevent visual light response type titanium oxide photocatalyst from coming into direct contact with a fiber fabric or a binder resin to thereby prevent decomposition of the fiber fabric or the binder resin by strong oxidizing effects of the visual light response type titanium oxide photocatalyst.

The average grain diameter of the visual light response type titanium oxide photocatalyst is preferably 5 nm to 20 μm. It is preferable that the average grain diameter of the visual light response type titanium oxide photocatalyst is smaller from the view point of its oxidative effects. It is also preferable that the grain diameter is not larger than one-tenth ( 1/10) of the fiber diameter from the view point of its easiness of the detachment. It is recommended to use the visual light response type titanium oxide photocatalyst having an average grain diameter of 20 μm or less. If the grain diameter of the titanium dioxide exceeds 20 μm, the decomposition removing rate of bad odor deteriorates, and therefore it is not preferable. Furthermore, it is technically difficult to produce a photocatalyst having a grain diameter less than 5 nm, which makes no business sense in cost. It is more preferable that the average grain diameter falls within the range of 7 nm to 5 μm.

The adhered amount of the visible light response type photocatalyst adhered to the fiber fabric is preferably 0.1 to 15 mass parts with respect to the fiber fabric 100 mass parts. If the adhered amount of the visible light response type photocatalyst adhered to the fiber fabric exceeds 15 mass parts, the texture of the fabric becomes hard and the fiber fabric whitens, and therefore it is not preferable. On the other hand, if it is less than 0.1 mass parts, since the decomposition rate and/or VOC decomposing rate deteriorate, and therefore it is not preferable. It is preferable that the adhered amount is 0.5 to 10 mass parts, more preferably 0.5 to 5 mass parts with respect to the fiber fabric 100 mass parts.

Next, in the third invention, effective deodorant effects can be attained by making a deodorant agent made of amine together with the visual light response type photocatalyst adhere to the fiber fabric. Although the amine compound is not specifically limited, hydrazine derivative or the like can be preferably used. Such amine compound has a property which absorbs and decomposes chemical substances such as formaldehyde, acetaldehyde, acetic acid. The solubility of the amine compound with respect to water is preferably 5 g/L or less at 25° C. The solubility with respect to water falling within this range prevents the amine compound from being dissolved in this water and flowing out even in cases where the amine compound comes into contact with water at the time of washing. As the hydrazine derivative, for example, hydrazine derivative obtained by reacting a hydrazine series compound and a long-chain aliphatic series compound and hydrazine derivative obtained by reacting a hydrazine series compound and an aromatic series compound can be exemplified.

Among other things, it is preferable to use a reaction product of one or more compounds selected from the group consisting of hydrazine and semicarbazide and one or more compounds selected from the group consisting of monocarboxylic acid, dicarboxylic acid, aromatic monocarboxylic acid and aromatic dicarboxylic acid having a carbon number of 8 to 16, or a reaction product of one or more compounds selected from the group consisting of hydrazine and semicarbazide and one or more compounds selected from the group consisting of monoglycidyl derivative and diglycidyl derivative. By using such hydrazine derivative, a further enhanced bad odor removing function can be secured. As the reaction product, sebacic acid dihydrazide, dodecane diacid dihydrazide, isophthalic acid dihydrazide can be exemplified, but not limited to these exemplified compounds.

The adhered amount of the deodorant agent made of an amine compound adhered to the fiber fabric is preferably 0.5 to 30 mass parts with respect to fiber fabric 100 mass parts. If the adhered amount of the deodorant agent made of an amine compound adhered to the fiber fabric exceeds 30 mass parts, the texture of the fabric becomes hard and the fiber fabric whitens, and therefore it is not preferable. On the other hand, if it is less than 0.5 mass parts, the odor decomposing deteriorates, and therefore it is not preferable. Among other things, it is more preferably 1 to 20 mass parts, further preferably 1 to 10 mass parts.

Furthermore, it is preferable that the average grain diameter of the amine compound is 20 nm to 30 μm. If the amine compound exceeds 30 μm, it is not preferable since the texture of the fiber fabric becomes hard. On the other hand, if it is less than 20 nm, it is very difficult in production and high in production cost, and therefore it is not preferable. More preferably, it is 100 nm to 10 μm.

Next, the acrylic silicone series binder resin can be a binder resin having a silicone group and an acrylic group capable of indirectly adhering a visual light response type photocatalyst, an absorbing agent and a deodorant agent to the fiber fabric. Concretely, a resin obtained by compounding and block-copolymerizing an acrylic resin and a silicon resin and a complex resin obtained by compounding a polymethacrylate resin and a silicon resin can be exemplified. The acrylic portion is rich in adhesion to fibers and can bond physically strongly. The bonding power to fibers, especially organic fibers such as, e.g., acrylic fibers, nylon fibers or polyester fibers, is very strong. The acrylic portion preferentially bonds to a fiber fabric, keeping the softness of the bonded portion, resulting in sufficient durability. The silicone portion is against oxidation degradation by a photocatalyst.

Next, as an absorbing agent, zeolite, activated carbon, silica gel, and oxidized silicon can be exemplified. Among other things, hydrophobic zeolite is white in color, and therefore it can be preferably applied to an interior fiber fabric which gives importance to color and/or design. Furthermore, since the hydrophobic zeolite is less in water absorption, it can quickly and effectively absorb bad smell and intermediate products to be created during the photocatalyst reactions even in the atmosphere high in humidity. It is preferable to use hydrophobic zeolite having a SiO₂/Al₂O₃ molar ratio of 30 or more, more preferably hydrophobic zeolite having SiO₂/Al₂O₃ molar ratio of 60 or more.

As a method of obtaining the hydrophobic zeolite, for example, a method of directly synthesizing high Si/Al ratio zeolite such as silicalite, a method of removing Al within the zeolite skeleton by a aftertreatment and a method of modifying the zeolite surface silanol group can be exemplified. As a method of removing Al in zeolite skelton by aftertreatment, a method of subjecting NH₄⁺ type or H⁺ type zeolite to hydrothermal treatment at high temperature and then to acid treatment, a method of removing Al directly by acid treatment and a method of treating in an EDTA water solution can be exemplified. As a method of modifying the zeolite surface silanol group, a method of introducing alkyl group (hydrophobic group) by the reaction to alkylsilane or alcohol can be exemplified.

It is preferable that the average grain diameter of the hydrophobic zeolite is 20 nm to 30 μm. If the average grain diameter of the hydrophobic zeolite exceeds 30 μm, it is not preferable since the texture of the fiber fabric becomes hard. On the other hand, if it is less than 20 nm, it is very difficult in production and high in production cost, and therefore it is not preferable. Among other things, it is preferably 100 nm to 10 μm.

The adhered amount of the absorbing agent adhered to the fiber fabric is preferably 0.5 to 20 mass parts with respect to fiber fabric 100 mass parts. If the adhered amount of the absorbing agent adhered to the fiber fabric exceeds 20 mass parts, the texture of the fabric becomes hard and the fiber fabric whitens, and therefore it is not preferable. On the other hand, if it is less than 0.5 mass parts, since the power of absorbing intermediate products or bad odor deteriorates, and therefore it is not preferable. Among other things, it is more preferably 1 to 10 mass parts, further more preferably 1 to 5 mass parts.

As a method of fixing the visual light response type photocatalyst, the absorbing agent and the deodorant agent to a fiber fabric by an acrylic silicon binder resin, an immersion method and a coating method can be exemplified. Since the acrylic silicon binder resin is water-soluble, a mixed solution of the photocatalyst, the absorbing agent and the deodorant agent can be easily obtained.

The immersion method is a method in which a fiber fabric is immersed in a mixed solution of an acrylic silicon binder resin, a visual light response type photocatalyst, an absorbing agent and a deodorant agent and then the fiber fabric is squeezed with a mangle and dried to thereby fix the visual light response type photocatalyst, the absorbing agent and the deodorant agent to the fiber fabric. This enables an even fixation.

The coating method is a method in which a mixed solution of an acrylic silicon binder resin, a visual light response type photocatalyst, an absorbing agent and a deodorant agent is coated to the fiber fabric and dried to thereby fix the visual light response type photocatalyst, the absorbing agent and the deodorant agent to the fiber fabric by drying them. This method can remarkably improve the productivity and can control the adhered amount at a high degree of accuracy. Although a concrete method of the coating method is not specifically limited, for example, a gravure roll method, a spray method, roll coater method, a transfer print method, and a screen print method can be exemplified.

Furthermore, the coating method is a useful processing method for applying the acrylic silicon binder resin not in an entirely applied manner forming a skin layer on the fiber fabric but in a mesh-like manner. In this method, the binder resin is not entirely adhered in a layer-like manner but adhered in a mesh-like manner, which allows relative movements of the strings constituting the fiber fabric. This secures the softness of the fiber fabric, and also keeps spaces for giving functions other than deodorant, antibacterial and antifouling functions, which in turn makes it possible to give additional functions such as, e.g., a fire resisting function, a water-shielding function and an oil-shielding function.

The blend ratio of the visual light response type photocatalyst, the absorbing agent, the deodorant agent and the acrylic silicon binder resin is not specifically limited. However, if the amount of the titanium oxide photocatalyst increases, the ratio of bonding probability of the titanium oxide photocatalyst to the fiber fabric increases, which causes deterioration of the fiber fabric. The blending quantity of the acrylic silicon binder resin increases, the acrylic silicon binder resin covers the surface of the titanium oxide photocatalyst and the deodorant agent, resulting in deterioration of the odor eliminating effect, the antibacterial effect, and the antifouling effect. Therefore, the blending balance of the visual light response type photocatalyst, the absorbing agent, the deodorant agent and the acrylic silicon binder resin is decided.

In order to sufficiently exert the deodorant power of the visual light response type photocatalyst, the fixing processing to the fiber fabric can be performed by separate two steps. That is, at the first step, only the acrylic silicon binder resin is fixed to the fiber fabric. Next, at the second step, the visual light response type photocatalyst, the absorbing agent and the deodorant agent are applied to the fiber fabric obtained at the first step, which enables even and efficient application of the visual light response type photocatalyst, the absorbing agent and the deodorant agent.

### EXAMPLE

Next, concrete examples of the first embodiment will be explained.

### Example 1

A dispersion liquid was obtained by mixing 1 mass part of a visual light response type titanium oxide (anatase type/anion dope type) photocatalyst having an average grain diameter of 10 nm and 1 mass part of hydrophobic zeolite (the molar ratio of SiO₂/Al₂O₃ is 80) having an average grain diameter of 5 μm in 78 mass parts of water and them sufficiently agitating it. An acrylic silicon binder resin (solid content: 50 mass %) 20 pass parts was added to the dispersion liquid to thereby obtain an evenly dispersed liquid. After immersing in the dispersion liquid, the polyester spunbonded nonwoven fabric (weight per unit area: 40 g/m²) (fiber diameter: 4 μm) was taken out of the liquid and dried. Thus, a fiber fabric having a VOC removing function was obtained. The adhered amount of the visual light response type titanium oxide photocatalyst adhered to the fiber fabric was 1.5 mass parts with respect to the fiber fabric 100 mass parts. The adhered amount of the hydrophobic zeolite adhered to the fiber fabric was 1.5 mass parts with respect to the fiber fabric 100 mass parts. The adhered amount of the binder resin adhered to the fiber fabric was 10 mass parts with respect to the fiber fabric 100 mass parts.

### Examples 2-11

### Comparative Examples 1 and 2

A fiber fabric having a VOC removing function was obtained in the same manner as in Example 1 except that a dispersion liquid having the compositions shown in Table 1 was used as a dispersion liquid. In Example 4, coconut activated carbon was used as the hydrophobic inorganic porous substance. In Example 5, as the photocatalyst, zinc oxide (ZnO) photocatalyst was used. Furthermore, in Example 6, as the binder resin, an acrylic resin (not containing silicon) (solid content: 50 mass %). In Comparative Example 1, the dispersion processing liquid didn't contain a hydrophobic inorganic porous substance. In Comparative Example 2, the dispersion processing liquid didn't contain a photocatalyst.

TABLE 1

| | Composition of dispersion liquid | | | |
|---|---|---|---|---|
| | Hydrophobic inorganic | | | |
| | porous substance | Photocatalyst | | |
| | (Type/Ave. grain | (Type/Ave. grain | | Binder resin |
| | diameter/Mass parts) | diameter/Mass parts) | Water | (Type/Mass parts) |
| Example 1 | Hydrophobic zeolite/ | TiO₂/10 nm/1 mass part | 78 mass parts | Acrylic silicon resin/ |
| | 5 μm/1 mass part | | | 20 mass parts |
| Example 2 | Hydrophobic zeolite/ | TiO₂/10 nm/2 mass parts | 77 mass parts | Acrylic silicon resin/ |
| | 5 μm/1 mass part | | | 20 mass parts |
| Example 3 | Hydrophobic zeolite/ | TiO₂/5 μm/1 mass part | 78 mass parts | Acrylic silicon resin/ |
| | 5 μm/1 mass part | | | 20 mass parts |
| Example 4 | Coconut activated carbon/ | TiO₂/10 nm/1 mass part | 78 mass parts | Acrylic silicon resin/ |
| | 20 μm/1 mass part | | | 20 mass parts |
| Example 5 | Hydrophobic zeolite/ | ZnO/10 nm/1 mass part | 78 mass parts | Acrylic silicon resin/ |
| | 5 μm/1 mass part | | | 20 mass parts |
| Example 6 | Hydrophobic zeolite/ | TiO₂/10 nm/1 mass part | 78 mass parts | Acrylic resin/ |
| | 5 μm/1 mass part | | | 20 mass parts |
| Example 7 | Hydrophobic zeolite/ | TiO₂/100 nm/3 mass parts | 76 mass parts | Acrylic silicon resin/ |
| | 5 μm/1 mass part | | | 20 mass parts |
| Example 8 | Hydrophobic zeolite/ | TiO₂/10 nm/1 mass part | 78 mass parts | Acrylic silicon resin/ |
| | 0.5 μm/1 mass part | | | 20 mass parts |
| Example 9 | Hydrophobic zeolite/ | TiO₂/10 nm/1 mass part | 77 mass parts | Acrylic silicon resin/ |
| | 0.1 μm/2 mass parts | | | 20 mass parts |
| Comp. | — | TiO₂/10 nm/1 mass part | 79 mass parts | Acrylic silicon resin/ |
| Example 1 | | | | 20 mass parts |
| Comp. | Hydrophobic zeolite/ | — | 79 mass parts | Acrylic silicon resin/ |
| Example 2 | 5 μm/1 mass part | | | 20 mass parts |
| Example 10 | Hydrophobic zeolite/ | TiO₂/50 μm/1 mass part | 78 mass parts | Acrylic silicon resin/ |
| | 5 μm/1 mass part | | | 20 mass parts |
| Example 11 | Hydrophobic zeolite/ | TiO₂/10 nm/1 mass part | 78 mass parts | Acrylic silicon resin/ |
| | 50 μm/1 mass part | | | 20 mass parts |

TABLE 2

| | Adhered amount (mass parts) | | |
|---|---|---|---|
| | (Adhered amount with respect to | | |
| | fiber fabric 100 mass parts) | | |
| | Hydrophobic inorganic | Photo- | Binder |
| | porous substance | catalyst | resin |
| Example 1 | 1.5 | 1.5 | 10 |
| Example 2 | 1.5 | 3.0 | 10 |
| Example 3 | 1.5 | 1.5 | 10 |
| Example 4 | 1.5 | 1.5 | 10 |
| Example 5 | 1.5 | 1.5 | 10 |
| Example 6 | 1.5 | 1.5 | 10 |
| Example 7 | 1.5 | 4.5 | 10 |
| Example 8 | 1.5 | 1.5 | 10 |
| Example 9 | 3.0 | 1.5 | 10 |
| Comp. Example 1 | — | 1.5 | 10 |
| Comp. Example 2 | 1.5 | — | 10 |
| Example 10 | 1.5 | 1.5 | 10 |
| Example 11 | 1.5 | 1.5 | 10 |

TABLE 3

| | Deodorant performance test results | | | | | | | |
|---|---|---|---|---|---|---|---|---|
| | | | Hydrogen | | Methyl | | | |
| | Ammonia | | sulfide | | mercaptan | | Acetic acid | |
| | Removing | | Removing | | Removing | | Removing | |
| | rate (%) | Evaluation | rate (%) | Evaluation | rate (%) | Evaluation | rate (%) | Evaluation |
| Ex. 1 | 100 | ⊚ | 88 | Δ | 86 | Δ | 98 | ⊚ |
| Ex. 2 | 100 | ⊚ | 94 | ◯ | 92 | ◯ | 100 | ⊚ |
| Ex. 3 | 100 | ⊚ | 90 | ◯ | 88 | Δ | 100 | ⊚ |
| Ex. 4 | 85 | Δ | 88 | Δ | 88 | Δ | 92 | ◯ |
| Ex. 5 | 100 | ⊚ | 96 | ⊚ | 95 | ⊚ | 86 | Δ |
| Ex. 6 | 100 | ⊚ | 86 | Δ | 85 | Δ | 90 | ◯ |
| Ex. 7 | 100 | ⊚ | 86 | Δ | 86 | Δ | 90 | ◯ |
| Ex. 8 | 100 | ⊚ | 88 | Δ | 86 | Δ | 98 | ⊚ |
| Ex. 9 | 100 | ⊚ | 90 | ◯ | 86 | Δ | 100 | ⊚ |
| Comp. Ex. 1 | 76 | X | 74 | X | 70 | X | 82 | ∇ |
| Comp. Ex. 2 | 87 | Δ | 85 | Δ | 86 | Δ | 76 | X |
| Ex. 10 | 87 | Δ | 82 | ∇ | 84 | ∇ | 82 | ∇ |
| Ex. 11 | 80 | ∇ | 80 | ∇ | 80 | ∇ | 82 | ∇ |

| | Deodorant performance test results | | | | | |
|---|---|---|---|---|---|---|
| | Acetaldehyde | | Formaldehyde | | Toluene | |
| | Removing | | Removing | | Removing | |
| | rate (%) | Evaluation | rate (%) | Evaluation | rate (%) | Evaluation |
| Ex. 1 | 96 | ⊚ | 100 | ⊚ | 98 | ⊚ |
| Ex. 2 | 98 | ⊚ | 100 | ⊚ | 100 | ⊚ |
| Ex. 3 | 98 | ⊚ | 100 | ⊚ | 100 | ⊚ |
| Ex. 4 | 93 | ◯ | 100 | ⊚ | 98 | ⊚ |
| Ex. 5 | 86 | Δ | 92 | ◯ | 89 | Δ |
| Ex. 6 | 86 | Δ | 88 | Δ | 100 | ⊚ |
| Ex. 7 | 92 | ◯ | 90 | ◯ | 96 | ⊚ |
| Ex. 8 | 95 | ⊚ | 100 | ⊚ | 98 | ⊚ |
| Ex. 9 | 96 | ⊚ | 100 | ⊚ | 100 | ⊚ |
| Comp. Ex. 1 | 86 | Δ | 92 | ◯ | 75 | X |
| Comp. Ex. 2 | 72 | X | 76 | X | 89 | Δ |
| Ex. 10 | 80 | ∇ | 82 | ∇ | 85 | Δ |
| Ex. 11 | 88 | Δ | 90 | ◯ | 92 | ◯ |

Each of the fiber fabrics produced as mentioned above was evaluated by the following test method. The results was shown in Tables 3 and 4.

<Deodorant Performance Test Method>

(Ammonia Deodorant Performance)

A test piece (10×10 cm square) fiber fabric was put in a bag 2 L volume. Then, ammonia gas was filled in the bag so that the concentration becomes 100 ppm. The bag was placed immediately below a fluorescent lamp (light intensity: 6,000 lux, ultraviolet: 50 μW/cm²) so as to be apart from the lamp by 30 cm. Two hours later, the remaining concentration of the ammonia gas was measured. From the measured value, the total amount of the ammonia gas decomposed by ammonia gas was measured to calculate the ammonia removing rate (%).

(Hydrogen Sulfide Deodorant Performance)

The removing rate (%) of hydrogen sulfide gas was calculated in the same manner as in the aforementioned ammonia gas deodorant performance measurement except that in place of the ammonia gas, hydrogen sulfide gas was used and the hydrogen sulfide gas was injected in a bag so that the concentration of hydrogen sulfide gas became 10 ppm.

(Methyl Mercaptan Deodorant Performance)

The removing rate (%) of methyl mercaptan gas was calculated in the same manner as in the aforementioned ammonia gas deodorant performance measurement except that in place of the ammonia gas, methyl mercaptan gas was used and the methyl mercaptan gas was injected in a bag so that the concentration of methyl mercaptan gas became 10 ppm.

(Acetic Acid Deodorant Performance)

The removing rate (%) of acetic acid gas was calculated in the same manner as in the aforementioned ammonia gas deodorant performance measurement except that in place of the ammonia gas, acetic acid gas was used and the acetic acid gas was injected in a bag so that the concentration of acetic acid gas became 10 ppm.

(Acetaldehyde Deodorant Performance)

The removing rate (%) of acetaldehyde gas was calculated in the same manner as in the aforementioned ammonia gas deodorant performance measurement except that in place of the ammonia gas, acetaldehyde gas was used and the acetaldehyde gas was injected in a bag so that the concentration of acetaldehyde gas became 10 ppm.

(Formaldehyde Deodorant Performance)

The removing rate (%) of formaldehyde gas was calculated in the same manner as in the aforementioned ammonia gas deodorant performance measurement except that in place of the ammonia gas, formaldehyde gas was used and the formaldehyde gas was injected in a bag so that the concentration of formaldehyde gas became 10 ppm.

(Toluene Deodorant Performance)

The removing rate (%) of toluene gas was calculated in the same manner as in the aforementioned ammonia gas deodorant performance measurement except that in place of the ammonia gas, toluene gas was used and the toluene gas was injected in a bag so that the concentration of toluene gas became 10 ppm.

Then, the removal rates were evaluated and the results are shown as follows:

95%≦=Removing rate: ⊚

90%≦Removing rate<95%: ◯

85%≦Removing rate<90%: Δ

80%≦Removing rate<85%: ∇

Removing rate<80%: X

<Antibacterial Performance Test>

The antibacterial performance of each piece was evaluated in accordance with an antibacterial test method JIS L1902 uniform method for fiber products. That is, as a test bacteria, Staphylococcus aureus clinical isolate was used. The test bacteria was applied to the sterile test piece and cultivated in a dark place and under a fluorescent lamp for 18 hours and then the viable count was measured to obtain the viable count with respect to the inoculation number. The results were evaluated by the following standard. That is, under the condition of log(B/A)>1.5, log(B/C) was defined as a fungi number increased/decreased value difference. When the value was 2.2 or more, it was evaluated as “Pass,” where A is the fungi number collected immediately after the inoculation of non-processed product, B is the fungi number collected after 18 hours cultivation of a non-processed product, and C is the fungi number collected after 18 hours cultivation of a processed product.

TABLE 4

Antibacterial performance evaluation

| | Example 1 | Comparative Example 2 |
|---|---|---|
| Dark place | 0.45 | 0.42 |
| Under a fluorescent lamp | 4.95 | 0.94 |

As apparent from the table, in the fiber fabrics of Examples 1-9 according to this invention, an excellent deodorant performance (VOC removing performance) was exerted against all of ammonia, hydrogen sulfide, methyl mercaptan, acetic acid, acetaldehyde, and formaldehyde. In the fiber fabrics of Examples 10 and 11 of this invention, a relatively good deodorant performance was exerted.

Furthermore, in the antibacterial test, in the case of Example 1 and Comparative Example 2, there is no difference in a dark place. However, under a fluorescent lamp, the fiber fabric of Example 1 showed an extremely excellent antibacterial performance.

On the other hand, in Comparative Example 1 containing no hydrophobic inorganic porous substance, the deodorant performance was not sufficient. Furthermore, in Comparative Example 2 containing no photocatalyst, the deodorant performance was also not sufficient.

Next, concrete examples of the second embodiment will be explained.

### Example 12

A dispersion liquid was obtained by mixing 4 mass part of a hydrophobic zeolite having an average grain diameter of 5 μm in which titanium oxide photocatalyst 0.4 mass parts was fixed in pores (containing titanium oxide 0.4 mass parts, hereinafter “deodorant agent A”) in 92 mass parts of water and then stirring them with a stirring machine. An acrylic silicon binder resin (solid content 50%) 4 pass parts is added to the dispersion liquid to thereby obtain an evenly dispersed liquid. After immersing in the dispersion liquid, the polyester spunbonded nonwoven fabric (weight per unit area: 130 g/m², fiber diameter: 4 μm) was taken out of the liquid and squeezed with a mangle to be dried. Thus, a fiber fabric having a VOC removing function was obtained. The adhered amount of the hydrophobic zeolite in which in which titanium oxide photocatalyst was fixed in pores adhered to the fiber fabric was 2 mass parts with respect to the fiber fabric 100 mass parts. The adhered amount of the binder resin adhered to the fiber fabric was 2 mass parts with respect to the fiber fabric 100 mass parts. The obtained fiber fabric having a VOC removing function was subjected to the aforementioned various gas deodorant tests. The removing rate and the evaluation are shown in the table.

### Example 13

A fiber fabric having a VOC removing function was obtained in the same manner as in Example 12 except that water 84 mass parts was added to a deodorant agent A 12 mass parts in Example 12. The adhered amount of the deodorant agent A adhered to the fiber fabric was 6 mass parts with respect to the fiber fabric 100 mass parts. Furthermore, the adhered amount of the binder resin adhered to the fiber fabric was 2 mass parts with respect to the fiber fabric 100 mass parts.

### Example 14

A fiber fabric having a VOC removing function was obtained in the same manner as in Example 12 except that in place of the acrylic silicon binder resin (solid content 50%), an acrylic resin (solid content 50%) 20 pass parts was added to the dispersion liquid. Furthermore, the adhered amount of the deodorant agent A adhered to the fiber fabric was 2 mass parts with respect to the fiber fabric 100 mass parts. The adhered amount of the binder resin adhered to the fiber fabric was 10 mass parts with respect to the fiber fabric 100 mass parts.

### Example 15

A fiber fabric having a VOC removing function was obtained in the same manner as in Example 12 except that in place of the hydrophobic zeolite, 4 mass parts (containing titanium oxide 0.4 mass parts) of a hydrophobic substance in which titanium oxide was fixed in pores of mesoporous silica having a grain diameter of 20 μm and then the surface of the mesoporous cilica was alkylated was added water. The adhered amount of the hydrophobic silica in which titanium oxide was fixed in pores adhered to the fiber fabric was 2 mass parts with respect to the fiber fabric 100 mass parts. The adhered amount of the binder resin adhered to the fiber fabric was 2 mass parts with respect to the fiber fabric 100 mass parts.

### Example 16

A fiber fabric having a VOC removing function was obtained in the same manner as in Example 12 except that a hydrophobic zeolite having an average grain diameter of 0.3 μm was used in Example 12. The adhered amount of the hydrophobic zeolite in which titanium oxide photocatalyst was fixed in pores adhered to the fiber fabric was 2 mass parts with respect to the fiber fabric 100 mass parts. The adhered amount of the binder resin adhered to the fiber fabric was 2 mass parts with respect to the fiber fabric 100 mass parts.

### Comparative Example 3

A fiber fabric was obtained in the same manner as in Example 12 except that 3.6 mass parts of a hydrophobic zeolite having an average grain diameter of 5 μm in which no titanium oxide photocatalyst was fixed in pores and 0.4 mass parts of a titanium oxide photocatalyst was used in Example 12. The adhered amount of the hydrophobic zeolite (no titanium oxide photocatalyst was fixed in pores) and the titanium oxide photocatalyst adhered to the fiber fabric was 2 mass parts with respect to the fiber fabric 100 mass parts. The adhered amount of the binder resin adhered to the fiber fabric was 2 mass parts with respect to the fiber fabric 100 mass parts.

### Comparative Example 4

A fiber fabric having a VOC removing function was obtained in Example 12, by applying a processing liquid with a spray to a fiber fabric and drying it. The adhered amount of the deodorant agent A adhered to the fiber fabric was 0.08 mass parts with respect to the fiber fabric 100 mass parts. Furthermore, the adhered amount of the binder resin adhered to the fiber fabric was 0.08 mass parts with respect to the fiber fabric 100 mass parts.

### Comparative Example 5

A fiber fabric having a VOC removing function was obtained in the same manner as in Example 12 except that a hydrophobic zeolite having an average grain diameter of 5 μm of the deodorant agent

A was replaced with a hydrophobe zeolite having an average grain diameter of 50 μm in Example 12. The adhered amount of the deodorant agent A adhered to the fiber fabric was 2 mass parts with respect to the fiber fabric 100 mass parts. Furthermore, the adhered amount of the binder resin adhered to the fiber fabric was 2 mass parts with respect to the fiber fabric 100 mass parts.

### Comparative Example 6

A fiber fabric having a VOC removing function was obtained in the same manner as in Example 12 except that a hydrophobic zeolite having an average grain diameter of 5 μm of the deodorant agent A was replaced with a hydrophilic zeolite in Example 12. The adhered amount of the deodorant agent A adhered to the fiber fabric was 2 mass parts with respect to the fiber fabric 100 mass parts. Furthermore, the adhered amount of the binder resin adhered to the fiber fabric was 2 mass parts with respect to the fiber fabric 100 mass parts.

Each of the fiber fabrics produced as mentioned above was evaluated by the following test method. The results were shown in Tables 5 and 6.

(Ammonia Deodorant Performance)

A test piece (10×10 cm square) fiber fabric cut out of each fiber fabric was put in a bag 2 L volume. Then, ammonia gas was filled in the bag so that the concentration becomes 100 ppm. The bag was placed immediately below a fluorescent lamp (light intensity: 6,000 lux, ultraviolet: 50 μW/cm²) so as to be apart from the lamp by 5 cm. Two hours later, the remaining concentration of the ammonia gas was measured. From the measured value, the total removed amount of the ammonia gas was calculated to thereby obtain the ammonia removing rate (%).

(Hydrogen Sulfide Deodorant Performance)

The removing rate (%) of hydrogen sulfide gas was calculated in the same manner as in the aforementioned ammonia gas deodorant performance measurement except that in place of the ammonia gas, hydrogen sulfide gas was used and the hydrogen sulfide gas was injected in a bag so that the concentration of hydrogen sulfide gas became 10 ppm.

(Methyl Mercaptan Deodorant Performance)

The removing rate (%) of methyl mercaptan gas was calculated in the same manner as in the aforementioned ammonia gas deodorant performance measurement except that in place of the ammonia gas, methyl mercaptan gas was used and the methyl mercaptan gas was injected in a bag so that the concentration of methyl mercaptan gas became 10 ppm.

(Acetic Acid Deodorant Performance)

The removing rate (%) of acetic acid gas was calculated in the same manner as in the aforementioned ammonia gas deodorant performance measurement except that in place of the ammonia gas, acetic acid gas was used and the acetic acid gas was injected in a bag so that the concentration of acetic acid gas became 10 ppm.

(Acetaldehyde Deodorant Performance)

The removing rate (%) of acetaldehyde gas was calculated in the same manner as in the aforementioned ammonia gas deodorant performance measurement except that in place of the ammonia gas, acetaldehyde gas was used and the acetaldehyde gas was injected in a bag so that the concentration of acetaldehyde gas became 10 ppm.

(Formaldehyde Deodorant Performance)

The removing rate (%) of formaldehyde gas was calculated in the same manner as in the aforementioned ammonia gas deodorant performance measurement except that in place of the ammonia gas, formaldehyde gas was used and the formaldehyde gas was injected in a bag so that the concentration of formaldehyde gas became 10 ppm.

(Toluene Deodorant Performance)

The removing rate (%) of toluene gas was calculated in the same manner as in the aforementioned ammonia gas deodorant performance measurement except that in place of the ammonia gas, toluene gas was used and the toluene gas was injected in a bag so that the concentration of toluene gas became 10 ppm.

Then, the removal rates were evaluated and the results are shown as follows:

95%≦Removing rate: ⊚

90%≦Removing rate<95%: ◯

85%≦Removing rate<90%: Δ

Removing rate<85%: X

When the rate is 85% or above, it is evaluated as “Pass.”

(Decomposition Evaluation of Substrate Such as the Binder Resin and the Fiber Fabric)

In the same manner as in the deodorant performance evaluation, a test piece (10×10 cm square) fiber fabric cut out of each fiber fabric was put in a bag 2 L volume. Then, pure air was filled in the bag. The bag was placed at immediately below a fluorescent lamp (light intensity: 6,000 lux, ultraviolet: 50 μW/cm²) so as to be apart from the lamp by 5 cm. Two hours later, the amount of the generated carbon dioxide was measured. When the value was 1 μg or less, it was evaluated as “Pass.”

<Antibacterial Performance Test>

Based on the aforementioned antibacterial performance test, the antibacterial performance was evaluated.

TABLE 5

| | Deodorant performance test results | | | | | | | |
|---|---|---|---|---|---|---|---|---|
| | | | Hydrogen | | Methyl | | | |
| | Ammonia | | sulfide | | mercaptan | | Acetic acid | |
| | Removing | | Removing | | Removing | | Removing | |
| | rate (%) | Evaluation | rate (%) | Evaluation | rate (%) | Evaluation | rate (%) | Evaluation |
| Ex. 12 | 100 | ⊚ | 88 | Δ | 92 | ◯ | 98 | ⊚ |
| Ex. 13 | 100 | ⊚ | 90 | ◯ | 93 | ◯ | 100 | ⊚ |
| Ex. 14 | 92 | ◯ | 86 | Δ | 89 | Δ | 95 | ⊚ |
| Ex. 15 | 89 | Δ | 88 | Δ | 87 | Δ | 92 | ◯ |
| Ex. 16 | 100 | ⊚ | 90 | ◯ | 94 | ◯ | 100 | ⊚ |
| Comp. Ex. 3 | 100 | ⊚ | 87 | Δ | 92 | ◯ | 97 | ⊚ |
| Comp. Ex. 4 | 75 | X | 62 | X | 73 | X | 82 | X |
| Comp. Ex. 5 | 100 | ⊚ | 87 | Δ | 89 | Δ | 100 | ⊚ |
| Comp. Ex. 6 | 100 | ⊚ | 89 | Δ | 90 | ◯ | 100 | ⊚ |

| | Deodorant performance test results | | | | | | | |
|---|---|---|---|---|---|---|---|---|
| | | | | | | | Substrate | |
| | | | | | | | decomposition | |
| | Acetaldehyde | | Formaldehyde | | Toluene | | Co₂ | |
| | Removing | | Removing | | Removing | | amount | |
| | rate (%) | Evaluation | rate (%) | Evaluation | rate (%) | Evaluation | (μg) | Evaluation |
| Ex. 12 | 96 | ⊚ | 100 | ⊚ | 98 | ⊚ | 0.1 | ◯ |
| Ex. 13 | 99 | ⊚ | 100 | ⊚ | 100 | ⊚ | 0.3 | ◯ |
| Ex. 14 | 92 | ◯ | 100 | ⊚ | 95 | ⊚ | 0.6 | ◯ |
| Ex. 15 | 92 | ◯ | 98 | ⊚ | 96 | ⊚ | 0.8 | ◯ |
| Ex. 16 | 100 | ⊚ | 100 | ⊚ | 100 | ⊚ | 0.6 | ◯ |
| Comp. Ex. 3 | 97 | ⊚ | 100 | ⊚ | 96 | ⊚ | 8 | X |
| Comp. Ex. 4 | 85 | Δ | 87 | Δ | 83 | X | 0.1 | ◯ |
| Comp. Ex. 5 | 92 | ◯ | 96 | ⊚ | 100 | ⊚ | 0.6 | ◯ |
| Comp. Ex. 6 | 70 | X | 100 | ⊚ | 62 | X | 0.4 | ◯ |

TABLE 6

| | Antibacterial performance evaluation | |
|---|---|---|
| | Example 12 | Comparative Example 4 |
| Dark place | 0.45 | 0.42 |
| Under a fluorescent lamp | 4.95 | 0.94 |

As will be understood from Table 5, the deodorant performance of each of the fiber fabrics of Examples 12-16 was satisfactory. However, in Comparative Example 3 in which no titanium oxide photocatalyst was fixed in pores, decomposition of a substrate starts, and therefore there is a problem in durability when it is used for a long term. In Comparative Example 4 with less application amount, the VOC removing performance was not satisfactory. In Comparative Example 5 with a larger grain diameter of the hydrophobic zeolite, although the deodorant performance was good, it was not satisfactory since the surface of the fiber fabric was rough. In Comparative Example 6 in which hydrophilia zeolite was used in place of the hydrophobic zeolite, the VOC removing performance could not be satisfied. Although an antibacterial performance test was performed in Example 12 and Comparative Example 4, there was not so big difference in a dark plate but a big difference under a fluorescent lamp as shown in Table 6.

Next, concrete examples according to the third invention will be explained.

### Example 17

A dispersion liquid was obtained by mixing 1 mass part of a visual light response type titanium oxide photocatalyst having an average grain diameter of 10 nm, 1 mass part of hydrophobic zeolite having an average grain diameter of 5 μm, and 2 mass parts of dihydrazide sebacate in 91 mass parts of water and then sufficiently agitating it. An acrylic silicon binder resin (solid content: 25%) 5 pass parts was added to the dispersion liquid to thereby obtain an evenly dispersed liquid (processing liquid). After immersing in the processing liquid, the polyester spunbonded nonwoven fabric (weight per unit area: 135 g/m²) was taken out of the liquid and dried with a mangle. Thus, a fiber fabric having a deodorant function was obtained. The adhered amount of the visual light response type titanium oxide photocatalyst adhered to the fiber fabric was 0.75 mass parts with respect to the fiber fabric 100 mass parts. The adhered amount of the hydrophobic zeolite adhered to the fiber fabric was 0.75 mass parts with respect to the fiber fabric 100 mass parts. The adhered amount of the dihydrazide sebacate adhered to the fiber fabric was 1.5 mass parts with respect to the fiber fabric 100 mass parts.

### Examples 18-24

### Comparative Examples 7-17

A fiber fabric having a deodorant function, an antibacterial function and a VOC removing function was obtained in the same manner as in Example 17 except that the processing liquid having the compositions shown in Table 7 was used as the processing liquid.

Each fiber fabric produced as mentioned above was evaluated in accordance with the following test method. The results are shown in Tables 9 and 10. That it, the performance evaluation of each example is shown in Table 9, and the antibacterial performance evaluations of Example 17 and Comparative Example 8 are shown in Table 10. Furthermore, the adhered amount to the fiber fabric of each example is shown in Table 8.

(Ammonia Deodorant Performance)

A fiber fabric (10×10 cm square) to which the visual light response type photocatalyst, the absorbing agent, and the deodorant agent were fixed was put in a bag 2 L volume. Then, ammonia gas was filled in the bag so that the concentration becomes 100 ppm. The bag was placed at immediately below a fluorescent lamp (light intensity: 6,000 lux, ultraviolet: 50 μW/cm²) so as to be apart from the lamp by 30 cm. Two hours later, the remaining concentration of the ammonia gas was measured. From the measured value, the total removed amount of the ammonia gas was calculated to thereby obtain the ammonia removing rate (%).

(Hydrogen Sulfide Deodorant Performance)

The removing rate (%) of hydrogen sulfide gas was calculated in the same manner as in the aforementioned ammonia gas deodorant performance measurement except that in place of the ammonia gas, hydrogen sulfide gas was used and the hydrogen sulfide gas was injected in a bag so that the concentration of hydrogen sulfide gas became 10 ppm.

(Methyl Mercaptan Deodorant Performance)

The removing rate (%) of methyl mercaptan gas was calculated in the same manner as in the aforementioned ammonia gas deodorant performance measurement except that in place of the ammonia gas, methyl mercaptan gas was used and the Methyl mercaptan gas was injected in a bag so that the concentration of methyl mercaptan gas became 10 ppm.

(Acetic Acid Deodorant Performance)

The removing rate (%) of acetic acid gas was calculated in the same manner as in the aforementioned ammonia gas deodorant performance measurement except that in place of the ammonia gas, acetic acid gas was used and the acetic acid gas was injected in a bag so that the concentration of acetic acid gas became 10 ppm.

(Acetaldehyde Deodorant Performance)

The removing rate (%) of acetaldehyde gas was calculated in the same manner as in the aforementioned ammonia gas deodorant performance measurement except that in place of the ammonia gas, acetaldehyde gas was used and the acetaldehyde gas was injected in a bag so that the concentration of acetaldehyde gas became 10 ppm.

(Formaldehyde Deodorant Performance)

The removing rate (%) of formaldehyde gas was calculated in the same manner as in the aforementioned ammonia gas deodorant performance measurement except that in place of the ammonia gas, formaldehyde gas was used and the formaldehyde gas was injected in a bag so that the concentration of formaldehyde gas became 10 ppm.

(Toluene Deodorant Performance)

The removing rate (%) of Toluene gas was calculated in the same manner as in the aforementioned ammonia gas deodorant performance measurement except that in place of the ammonia gas, toluene gas was used and the toluene gas was injected in a bag so that the concentration of toluene gas became 10 ppm.

Then, the removing rates were evaluated and the results are shown as follows:

95%≦Removing rate: ⊚

90%≦Removing rate<95%: ◯

85%≦Removing rate<90%: Δ

80%≦Removing rate<85%: ∇

Removing rate<80%: X (Failed)

<Antibacterial Performance Test>

Based on the aforementioned antibacterial performance test, the antibacterial performance was evaluated.

(Stability of Mixed Liquid)

The mixed liquid of 90 ml was put in a UM sample bottle 100 ml, and stored it in an incubator at 45° C. for 120 hours. The deposition status of the agent was visually observed. Then, it was evaluated as follows:

the layer's width of the clear upper portion≦2 mm: ◯

2 mm<the layer's width of the clear upper portion<5 mm: Δ

5 mm≦the layer's width of the clear upper portion: X

### (Failed)

(Texture (Roughness))

The carpet was touched with a hand. The roughness was evaluated by the following judging standard.

No roughness: ⊚

Almost no roughness: ◯

Slight roughness: Δ

Extremely roughness: X

TABLE 7

| | Composition of dispersion liquid | | | | | |
|---|---|---|---|---|---|---|
| | Hydrophobic inorganic | | | | | |
| | porous substance | Photocatalyst | Deodorant agent | | | |
| | (Type/Ave. grain | (Type/Ave. grain | (Type/Ave. grain | | | Binder resin |
| | diameter/Mass part) | diameter/Mass part) | diameter/Mass part) | Water | | (Type/Mass) |
| Ex. 17 | Hydrophobic zeolite/ | TiO₂/10 nm/ | Sebacic acid dihydrazine | 91 | mass parts | Acrylic silicon resin/ |
| | 5 μm/1 mass part | 1 mass part | 1 μm/2 mass parts | | | 5 mass parts |
| Ex. 18 | Hydrophobic zeolite/ | TiO₂/10 nm/ | Sebacic acid dihydrazine/ | 90.7 | mass parts | Acrylic silicon resin/ |
| | 5 μm/1.3 mass parts | 1 mass part | 1 μm/2 mass parts | | | 5 mass parts |
| Ex. 19 | Hydrophobic zeolite/ | TiO₂/10 nm/ | Sebacic acid dihydrazine/ | 85.3 | mass parts | Acrylic silicon resin/ |
| | 50 nm/6.7 mass parts | 1 mass part | 50 nm/2 mass parts | | | 5 mass parts |
| Ex. 20 | Hydrophobic zeolite/ | TiO₂/10 μm/ | Sebacic acid dihydrazine/ | 91.2 | mass parts | Acrylic silicon resin/ |
| | 5 μm/1.3 mass parts | 0.5 mass parts | 1 μm/2 mass parts | | | 5 mass parts |
| Ex. 21 | Hydrophobic zeolite/ | TiO₂/10 nm/ | Sebacic acid dihydrazine/ | 85 | mass parts | Acrylic silicon resin/ |
| | 25 μm/1.3 mass parts | 6.7 mass parts | 1 μm/2 mass parts | | | 5 mass parts |
| Ex. 22 | Hydrophobic zeolite/ | TiO₂/50 nm/ | Sebacic acid dihydrazine/ | 91.2 | mass parts | Acrylic silicon resin/ |
| | 5 μm/1.3 mass parts | 1 mass part | 1 μm/1 mass part | | | 5 mass parts |
| Ex. 23 | Hydrophobic zeolite/ | TiO₂/10 nm/ | Sebacic acid dihydrazine/ | 79.4 | mass parts | Acrylic silicon resin/ |
| | 5 μm/1.3 mass parts | 1 mass part | 20 μm/13.3 mass parts | | | 5 mass parts |
| Ex. 24 | Coconut activated carbon/ | TiO₂/10 nm/ | Isophthalic dihydrazine/ | 90.7 | mass parts | silicon resin/ |
| | 5 μm/1.3 mass parts | 1 mass part | 1 μm/2 mass parts | | | 5 mass parts |
| Comp. | — | TiO₂/10 nm/ | Sebacic acid dihydrazine/ | 92 | mass parts | Acrylic silicon resin/ |
| Ex. 7 | | 1 mass part | 1 μm/2 mass parts | | | 5 mass parts |
| Comp. | Hydrophobic zeolite/ | — | Sebacic acid dihydrazine/ | 91.7 | mass parts | Acrylic silicon resin/ |
| Ex. 8 | 5 μm/1.3 mass parts | | 1 μm/2 mass parts | | | 5 mass parts |
| Comp. | Hydrophobic zeolite/ | TiO₂/10 nm/ | — | 92.7 | mass parts | Acrylic silicon resin/ |
| Ex. 9 | 5 μm/1.3 mass parts | 1 mass part | | | | 5 mass parts |
| Comp. | Hydrophobic zeolite/ | TiO₂/10 nm/ | Sebacic acid dihydrazine/ | 92.62 | mass parts | Acrylic silicon resin/ |
| Ex. 10 | 5 μm/1.3 mass parts | 1 mass part | 1 μm/0.1 mass parts | | | 5 mass parts |
| Comp. | Hydrophobic zeolite/ | TiO₂/10 nm/ | Sebacic acid dihydrazine/ | 61.12 | mass parts | Acrylic silicon resin/ |
| Ex. 11 | 5 μm/33.3 mass parts | 0.03 mass parts | 1 μm/0.75 mass parts | | | 5 mass parts |
| Comp. | Hydrophobic zeolite/ | TiO₂/10 nm/ | Sebacic acid dihydrazine/ | 67.72 | mass parts | Acrylic silicon resin/ |
| Ex. 12 | 5 μm/0.03 mass parts | 26.7 mass parts | 1 μm/0.75 mass parts | | | 5 mass parts |
| Comp. | Hydrophobic zeolite/ | TiO₂/10 nm/ | Sebacic acid dihydrazine/ | 46 | mass parts | Acrylic silicon resin/ |
| Ex. 13 | 5 μm/1.3 mass parts | 1 mass part | 1 μm/46.7 mass parts | | | 5 mass parts |
| Comp. | Hydrophobic zeolite/ | TiO₂/10 nm/ | Sebacic acid dihydrazine/ | 90.7 | mass parts | Acrylic silicon resin/ |
| Ex. 14 | 10 μm/1.3 mass parts | 1 mass part | 1 μm/2 mass parts | | | 5 mass parts |
| Comp. | Hydrophobic zeolite/ | TiO₂/10 nm/ | Sebacic acid dihydrazine/ | 90.7 | mass parts | Acrylic silicon resin/ |
| Ex. 15 | 40 μm/1.3 mass parts | 1 mass part | 1 μm/2 mass parts | | | 5 mass parts |
| Comp. | Hydrophobic zeolite/ | TiO₂/25 μm/ | Sebacic acid dihydrazine/ | 90.7 | mass parts | Acrylic silicon resin/ |
| Ex. 16 | 5 μm/1.3 mass parts | 1 mass part | 1 μm/2 mass parts | | | 5 mass parts |
| Comp. | Hydrophobic zeolite/ | TiO₂/10 nm/ | Sebacic acid dihydrazine/ | 90.7 | mass parts | Acrylic silicon resin/ |
| Ex. 17 | 5 μm/1.3 mass parts | 1 mass part | 35 μm/2 mass parts | | | 5 mass parts |

TABLE 8

| | Adhered amount (mass parts) | | | | | | |
|---|---|---|---|---|---|---|---|
| | (Adhered amount with respect to fiber fabric 100 mass parts) | | | | | | |
| | Hydrophobic | | | | | | |
| | inorganic porous | | | | Deodorant | | |
| | substance | | Photocatalyst | | agent | | Binder resin |
| Ex. 17 | 0.75 | mass parts | 0.75 | mass parts | 1.5 | mass parts | 1 mass part |
| Ex. 18 | 1 | mass part | 0.75 | mass parts | 1.5 | mass parts | 1 mass part |
| Ex. 19 | 5 | mass parts | 0.75 | mass parts | 1.5 | mass parts | 1 mass part |
| Ex. 20 | 1 | mass part | 0.3 | mass parts | 1.5 | mass parts | 1 mass part |
| Ex. 21 | 1 | mass part | 5 | mass parts | 1.5 | mass parts | 1 mass part |
| Ex. 22 | 1 | mass part | 0.75 | mass parts | 0.75 | mass parts | 1 mass part |
| Ex. 23 | 1 | mass part | 0.75 | mass parts | 10 | mass parts | 1 mass part |
| Ex. 24 | 1 | mass part | 0.75 | mass parts | 1.5 | mass parts | 1 mass part |
| Comp. Ex. 7 | — | | 0.75 | mass parts | 1.5 | mass parts | 1 mass part |
| Comp. Ex. 8 | 1 | mass part | — | | 1.5 | mass parts | 1 mass part |
| Comp. Ex. 9 | 1 | mass part | 0.75 | mass parts | — | | 1 mass part |
| Comp. Ex. 10 | 1 | mass part | 0.75 | mass parts | 0.08 | mass parts | 1 mass part |
| Comp. Ex. 11 | 25 | mass parts | 0.02 | mass parts | 0.56 | mass parts | 1 mass part |
| Comp. Ex. 12 | 0.02 | mass parts | 20 | mass parts | 0.56 | mass parts | 1 mass part |
| Comp. Ex. 13 | 1 | mass part | 0.75 | mass parts | 35 | mass parts | 1 mass part |
| Comp. Ex. 14 | 1 | mass part | 0.75 | mass parts | 1.5 | mass parts | 1 mass part |
| Comp. Ex. 15 | 1 | mass part | 0.75 | mass parts | 1.5 | mass parts | 1 mass part |
| Comp. Ex. 16 | 1 | mass part | 0.75 | mass parts | 1.5 | mass parts | 1 mass part |
| Comp. Ex. 17 | 1 | mass part | 0.75 | mass parts | 1.5 | mass parts | 1 mass part |

TABLE 9

| | Deodorant performance test results | | | | | | | |
|---|---|---|---|---|---|---|---|---|
| | | | Hydrogen | | Methyl | | | |
| | Ammonia | | sulfide | | mercaptan | | Acetic acid | |
| | Removing | | Removing | | Removing | | Removing | |
| | rate (%) | Evaluation | rate (%) | Evaluation | rate (%) | Evaluation | rate (%) | Evaluation |
| Ex. 17 | 100 | ⊚ | 100 | ⊚ | 96 | ⊚ | 99 | ⊚ |
| Ex. 18 | 100 | ⊚ | 100 | ⊚ | 96 | ⊚ | 99 | ⊚ |
| Ex. 19 | 95 | ⊚ | 94 | ◯ | 95 | ⊚ | 100 | ⊚ |
| Ex. 20 | 96 | ⊚ | 95 | ⊚ | 91 | ◯ | 96 | ⊚ |
| Ex. 21 | 93 | ◯ | 94 | ◯ | 96 | ⊚ | 94 | ◯ |
| Ex. 22 | 93 | ◯ | 91 | ◯ | 87 | Δ | 94 | ◯ |
| Ex. 23 | 100 | ⊚ | 100 | ⊚ | 96 | ⊚ | 98 | ⊚ |
| Ex. 24 | 91 | ◯ | 89 | Δ | 82 | ∇ | 92 | ◯ |
| Comp. Ex. 7 | 98 | ⊚ | 98 | ⊚ | 89 | Δ | 98 | ⊚ |
| Comp. Ex. 8 | 99 | ⊚ | 99 | ⊚ | 90 | ◯ | 98 | ⊚ |
| Comp. Ex. 9 | 72 | X | 12 | X | 44 | X | 82 | ∇ |
| Comp. Ex. 10 | 87 | Δ | 30 | X | 52 | X | 89 | Δ |
| Comp. Ex. 11 | 93 | ◯ | 91 | ◯ | 87 | Δ | 94 | ◯ |
| Comp. Ex. 12 | 94 | ◯ | 92 | ◯ | 88 | Δ | 95 | ◯ |
| Comp. Ex. 13 | 100 | ⊚ | 100 | ⊚ | 96 | ⊚ | 99 | ⊚ |
| Comp. Ex. 14 | 99 | ⊚ | 95 | ⊚ | 91 | ◯ | 100 | ⊚ |
| Comp. Ex. 15 | 96 | ⊚ | 92 | ◯ | 95 | ⊚ | 98 | ⊚ |
| Comp. Ex. 16 | 95 | ⊚ | 94 | ◯ | 93 | ◯ | 96 | ⊚ |
| Comp. Ex. 17 | 94 | ◯ | 93 | ◯ | 92 | ◯ | 95 | ⊚ |
| | Deodorant performance test results | | | | | | | |
| | Acetaldehyde | | Formaldehyde | | Toluene | | Stability | |
| | Removing | | Removing | | Removing | | of mixed | |
| | rate (%) | Evaluation | rate (%) | Evaluation | rate (%) | Evaluation | liquid | Textuure |
| Ex. 17 | 94 | ◯ | 95 | ⊚ | 91 | ◯ | ◯ | ⊚ |
| Ex. 18 | 94 | ◯ | 95 | ⊚ | 97 | ⊚ | ◯ | ⊚ |
| Ex. 19 | 97 | ⊚ | 97 | ⊚ | 98 | ⊚ | ◯ | ⊚ |
| Ex. 20 | 94 | ◯ | 95 | ⊚ | 95 | ⊚ | ◯ | ⊚ |
| Ex. 21 | 96 | ⊚ | 98 | ⊚ | 99 | ⊚ | ◯ | ◯ |
| Ex. 22 | 96 | ⊚ | 98 | ⊚ | 97 | ⊚ | Δ | ⊚ |
| Ex. 23 | 96 | ⊚ | 98 | ⊚ | 98 | ⊚ | ◯ | ◯ |
| Ex. 24 | 88 | Δ | 87 | Δ | 91 | ◯ | ◯ | ⊚ |
| Comp. Ex. 7 | 87 | Δ | 91 | ◯ | 20 | X | ◯ | ⊚ |
| Comp. Ex. 8 | 88 | Δ | 91 | ◯ | 62 | X | ◯ | ⊚ |
| Comp. Ex. 9 | 57 | X | 76 | X | 91 | ◯ | ◯ | ⊚ |
| Comp. Ex. 10 | 82 | ∇ | 80 | ∇ | 94 | ◯ | X | Δ |
| Comp. Ex. 11 | 89 | Δ | 89 | Δ | 97 | ⊚ | X | Δ |
| Comp. Ex. 12 | 85 | Δ | 86 | Δ | 41 | X | X | X |
| Comp. Ex. 13 | 98 | ⊚ | 95 | ⊚ | 97 | ⊚ | X | X |
| Comp. Ex. 14 | 94 | ◯ | 95 | ⊚ | 91 | ◯ | X | X |
| Comp. Ex. 15 | 92 | ◯ | 91 | ◯ | 92 | ◯ | X | X |
| Comp. Ex. 16 | 97 | ⊚ | 97 | ⊚ | 92 | ◯ | X | X |
| Comp. Ex. 17 | 93 | ◯ | 92 | ◯ | 93 | ◯ | X | X |

TABLE 10

| | Antibacterial performance evaluation | |
|---|---|---|
| | Example 17 | Comparative Example 8 |
| Dark place | 0.45 | 0.45 |
| Under a fluorescent lamp | 4.95 | 0.94 |

As will be understood from Table 9, the deodorant performance of the fiber fabric of Examples 17-24 of the invention was satisfactory. However, in Comparative Example 17 with no absorbing agent, Comparative Example 8 with no photocatalyst, and Comparative Example 9 with no deodorant agent, the deodorant performance was not satisfied. Furthermore, even if the grain diameter of the absorbing agent, the photocatalyst, and the deodorant agent was large or small, it was not satisfactory. Although the antibacterial test was performed in Example 17 and Comparative Example 8, it was evaluated that there was not so big difference in the case of a dark place but there was a big difference under a fluorescent lamp as shown in table 10.

This application claims to Japanese Patent Application No. 2004-312119 filed on Oct. 27, 2004, Japanese Patent Application No. 2004-352214 filed on Dec. 6, 2004, and Japanese Patent Application No. 2005-153247 filed on May 26, 2005, the entire disclosures of which are incorporated herein by reference in their entireties.

The terms and expressions which have been employed herein are used as terms of description and not of limitation, and there is no intent, in the use of such terms and expressions, of excluding any of the equivalents of the features shown and described or portions thereof, but it is recognized that various modifications are possible within the scope of the invention claimed.

### INDUSTRIAL APPLICABILITY

The fiber fabric of the present invention is wide in applicable field, and can be widely applied to clothes, interior fiber fabrics such as, e.g., curtains fabrics, carpet fabrics, wallpaper fabrics, upholstery fabrics for vehicles, and ceiling materials.

1. A fiber fabric having a VOC removing function,
wherein a hydrophobic zeolite having a SiO₂/Al₂O₃ molar ratio of 30 or more and a photocatalyst are fixed to at least a part of the fiber fabric with a binder resin.

2. (canceled)

3. The fiber fabric having a VOC removing function as recited in claim 1, wherein the photocatalyst is visible light response type titanium oxide photocatalyst.

4. The fiber fabric having a VOC removing function as recited in claim 1, wherein the binder resin is an acrylic silicon series binder resin.

5. The fiber fabric having a VOC removing function as recited in claim 1, wherein an average grain diameter of the hydrophobic zeolite is 20 nm to 30 μm.

6. The fiber fabric having a VOC removing function as recited in claim 1, wherein an average grain diameter of the photocatalyst is 5 nm to 20 μm.

7. The fiber fabric having a VOC removing function as recited in claim 1, wherein an average grain diameter of the photocatalyst is not larger than one-tenth part ( 1/10) of a diameter of a fiber constituting the fiber fabric.

8. The fiber fabric having a VOC removing function as recited in claim 1,
wherein an adhered amount of the hydrophobic zeolite adhered to the fiber fabric is 0.1 to 15 mass parts with respect to the fiber fabric 100 mass parts,
wherein an adhered amount of the photocatalyst adhered to the fiber fabric is 0.5 to 25 mass parts with respect to the fiber fabric 100 mass parts, and
wherein an adhered amount of the binder resin adhered to the fiber fabric is 0.05 to 30 mass parts with respect to the fiber fabric 100 mass parts.

9. The fiber fabric having a VOC removing function as recited in claim 1, wherein the binder resin is fixed to the fiber fabric in an approximately mesh-like manner.

10. A fiber fabric having a VOC removing function, wherein a hydrophobic zeolite in which a photocatalyst is fixed in a cell is fixed to at least a part of a fiber fabric with a binder resin and
wherein a SiO₂/Al₂O₃ molar ratio of the hydrophobic zeolite is 30 or more.

11. (canceled)

12. The fiber fabric having a VOC removing function as recited in claim 10, wherein an average grain diameter of the hydrophobic zeolite is 20 nm to 30 μm.

13. The fiber fabric having a VOC removing function as recited in claim 10, wherein an average grain diameter of the hydrophobic zeolite is not larger than one-tenth part ( 1/10) of a diameter of a fiber constituting the fiber fabric.

14. The fiber fabric having a VOC removing function as recited in claim 10,
wherein an adhered amount of the hydrophobic zeolite in which the photocatalyst is fixed in the cell adhered to the fiber fabric is 0.1 to 15 mass parts with respect to the fiber fabric 100 mass parts, and
wherein an adhered amount of the binder resin adhered to the fiber fabric is 0.05 to 30 mass parts with respect to the fiber fabric 100 mass parts.

15. The fiber fabric having a VOC removing function as recited in claim 10, wherein the binder resin is fixed to the fiber fabric in an approximately mesh-like manner.

16. A fiber fabric having deodorant,
antibacterial and VOC removing functions, wherein a visible light response type photocatalyst, an absorbing agent made of a hydrophobic zeolite having a SiO₂/Al₂O₃ molar ratio of 30 or more and a deodorant made of an amine compound are fixed to at least a part of a fiber fabric with a binder resin.

17. The fiber fabric having deodorant, antibacterial and VOC removing functions as recited in claim 16, wherein the visible light response type photocatalyst is visible light response type titanium oxide photocatalyst.

18. (canceled)

19. The fiber fabric having deodorant, antibacterial and VOC removing functions as recited in claim 16, wherein the deodorant made of the amine compound is hydrazine derivative.

20. The fiber fabric having deodorant, antibacterial and VOC removing functions as recited in claim 16, wherein the binder resin is an acrylic silicon series binder resin.

21. The fiber fabric having deodorant, antibacterial and VOC removing functions as recited in claim 16, wherein an average grain diameter of the visible light response type photocatalyst is 5 nm to 20 μm.

22. The fiber fabric having deodorant, antibacterial and VOC removing functions as recited in claim 16, wherein an average grain diameter of the absorbing agent made of the hydrophobic zeolite is 20 nm to 30 μm.

23. The fiber fabric having deodorant, antibacterial and VOC removing functions as recited in claim 16, wherein an average grain diameter of the deodorant made of the amine compound is 20 nm to 30 μm.

24. The fiber fabric having deodorant, antibacterial and VOC removing functions as recited in claim 16,
wherein an adhered amount of the visible light response type photocatalyst adhered to the fiber fabric is 0.1 to 15 mass parts with respect to the fiber fabric 100 mass parts,
wherein an adhered amount of the absorbing agent made of the hydrophobic zeolite adhered to the fiber fabric is 0.5 to 20 mass parts with respect to the fiber fabric 100 mass parts, and
wherein an adhered amount of the deodorant made of the amine compound adhered to the fiber fabric is 0.5 to 30 mass parts with respect to the fiber fabric 100 mass parts.
